(19) United States
(12) Patent Application Publication
(10) Pub. No.: US 2013/0295555 A1
(43) Pub. Date: Nov. 7, 2013

(54) BIO-MOLECULE DETECTING DEVICE AND BIO-MOLECULE DETECTING METHOD

(71) Applicant: FUJIFLM CORPORATION, Tokyo (JP)

(72) Inventor: Toshihito KIMURA, Ashigarakami-gun (JP)

(21) Appl. No.: 13/935,097

(22) Filed: Jul. 3, 2013

Related U.S. Application Data
(63) Continuation of application No. PCT/JP2012/056882, filed on Mar. 16, 2012.

(30) Foreign Application Priority Data
Mar. 31, 2011 (JP) 2011-079280

(51) Int. Cl. G01N 21/17

(52) U.S. Cl. CPC G01N 21/17
USPC 435/5; 422/69; 436/501; 435/7.1; 435/6.11; 435/287.2; 435/288.7

(57) ABSTRACT

A bio-molecule detecting device that enables high-sensitivity measurement is provided. The bio-molecule detecting device was configured so that the orientation directions of free molecules and binding molecules in a solution are switched by switching the radiation direction of orientation control light, whereby the light extinction amount can be changed using nanorods associated with the free molecules and the binding molecules. In addition, between the free molecules and the binding molecules, there is a difference in the necessary time for the orientation direction to be switched by switching the radiation direction of the orientation control light, and therefore the timings, at which the light extinction amounts by the respective molecules change, are different.

### BACKGROUND OF THE INVENTION

1. Field of the Invention

The present invention relates to a technique that detects detection subject substances in a solution, and particularly to a bio-molecule detecting device and a bio-molecule detecting method which can detect bio-molecules, viruses, DNAs, proteins, microbes and the like in a specimen, such as blood or urine.

2. Description of the Related Art

In recent years, attention has been paid to a bio-molecule detecting method that enables doctors, engineers and the like to detect bio-molecules in a medical examination place and immediately obtain measurement results, thereby helping diagnoses or cures. The bio-molecule detecting method is a method that selectively detects only detection subject substances in a body fluid including a plurality of components, such as blood, urine and sweat, using a high selectivity obtained by using a specific reaction, such as an antigen-antibody reaction. Particularly, the bio-molecule detecting method is widely used in the trace detection, inspection, quantity determination, analysis and the like of bio-molecules, such as viruses, DNAs, proteins and microbes.

In recent years, as a method for detecting bio-molecules at high sensitivity, studies are underway regarding a plasmon sensor in which an interaction between plasmons of fine metal particles and light is used.

JP2009-265062A discloses an analysis chip in which a phenomenon, in which absorption wavelengths of localized surface plasmon resonances of fine metal particles (gold nanorods) fixed to a substrate are shifted due to specific bonds, is applied to a sensing technique.

JP2007-248284A discloses a sensing element that improves a detecting sensitivity by orienting and fixing gold nanorods to a substrate.

### SUMMARY OF THE INVENTION

However, for the sensing element in which a fine metal particle-fixed substrate as described in JP2009-265062A and JP2007-248284A is used, there is a problem in that the cost of labor for fixing fine metal particles is high.

The invention has been made in consideration of the above described circumstance, and an object of the invention is to provide a bio-molecule detecting device and a bio-molecule detecting method which can perform a measurement at high sensitivity without fixing fine metal particles to a substrate.

In order to achieve the aforementioned object, a bio-molecule detecting device according to the invention includes an orientation control unit that, in a solution including first complexes having a substance that can specifically bond to a specific bio-molecule and a detection label exhibiting anisotropic light absorption characteristics and second complexes in which the bio-molecule is specifically bonded to the first complexes through the substance, orients the first complexes and the second complexes in at least two directions; a first light source that radiates first light having a linearly-polarized light component in a specific direction on the solution; a detection unit that measures a light extinction amount of the first light by the solution; and a computation unit that carries out detection or quantity determination of the bio-molecule based on the light extinction amount of the light measured using the detection unit, in which the first light is light having a wavelength at which the light extinction amount by the detection label is changed by a change in orientation directions of the first complexes and the second complexes.

Here, the first complex refers to a free molecule in Embodiment 1. The second complex refers to a binding molecule in Embodiment 1.

Here, the detection label exhibiting anisotropic light absorption characteristics refers to a label in which a change in the orientation with respect to a vibration direction of light causes a change in the light extinction amount of the light, and specific examples thereof include a metal nanorod, a carbon nanotube and the like. A s the metal nanorod, for example, a gold nanorod can be used.

In addition, the light extinction amount is made up of contributions of both the amount of absorbed light and the amount of scattered light. In the invention, an absorbance may be measured, or scattered light may be measured as the light extinction amount. In addition, both the absorbance and the scattered light may be measured as the light extinction amount.

When the bio-molecule detecting device is configured as described above, a detection subject substance can be measured at high sensitivity with a simple configuration. In addition, since the first complexes and the second complexes are not fixed, a reaction in the solution is fast.

In addition, the first light is preferably light in which changes in the orientation directions of the first complexes and the second complexes using the orientation control unit causes a change in the orientation relationship between the detection label and the linearly-polarized light component in a specific direction so that the light extinction amount by the detection label changes.

The orientation control unit preferably has a second light source that radiates second light on the solution; and a switching unit that orients the first complexes and the second complexes in at least two directions in the solution by switching the radiation direction of the second light.

When the orientation control unit orients the first complexes and the second complexes using light, a pretreatment for orienting the first complexes and the second complexes becomes unnecessary. For example, in a case in which the orientation is controlled using magnetism, it is necessary to bond magnetic particles and the like to the first complexes and the second complexes; however, when the first complexes and the second complexes are oriented using light, such a pretreatment is not necessary.

In addition, the orientation control unit may include a third light source that radiates third linearly-polarized light on the solution; and a polarization axis rotational movement unit that orients the first complexes and the second complexes in at least two directions in the solution by rotationally moving the polarization axis of the third light.

When the first complexes and the second complexes are oriented in the above manner, since it is not necessary to radiate light from a plurality of directions unlike a case in which the orientation is switched by switching the radiation direction of light, an optical system in the orientation control unit can be miniaturized.

In addition, the computation unit preferably separates a light extinction amount component by the first complexes and a light extinction amount component by the second complexes using a fact that there is a difference in the changes of the light extinction amounts over time by the first complexes and by the second complexes, which are oriented using the orientation control unit, and carries out the detection or quantity determination of the bio-molecule.

Between the first complexes and the second complexes, there is a difference in the degree of ease of movement in the solution and the change of the light extinction amount over time. The computation unit can separate the light extinction amount by the first complexes and the light extinction amount by the second complexes using the difference in the change over time, and thus can detect the bio-molecule.

In addition, the detection label is preferably a metal nanorod. The metal nanorod exhibits a large change in the light extinction amount due to the switching of the orientation direction. Therefore, high-accuracy detection can be carried out.

The orientation control unit preferably orients the first complexes and the second complexes in a first direction in which a long-axis direction of the nanorod and the vibration direction of the light radiated from the first light source become parallel, and in a second direction in which a long-axis direction of the nanorod and the vibration direction of the light radiated from the first light source become vertical.

When the orientations of the molecules are controlled in the above manner, the change in the light extinction amount caused by the switching of the orientation direction of the first complexes and the orientation direction of the second complexes becomes the maximum. Therefore, the extent of contribution of the first complexes and the extent of contribution of the second complexes with respect to the light extinction amount of the solution can be more accurately measured.

In addition, it is preferable that the orientation control unit change the orientation directions of the first complexes and the second complexes at predetermined time intervals, the detection unit measure the light extinction amount a plurality of times, and the computation unit carry out the detection or quantity determination of the bio-molecule based on the arithmetic average of the light extinction amounts measured a plurality of times.

When the light extinction amount of the first complexes and the light extinction amount of the second complexes are measured a plurality of times in the above manner, and a plurality of the light extinction amounts is arithmetically averaged, the influence of a variation in the light extinction amount among the respective measurements, which is caused by noise or the like, on the measurement accuracy can be reduced.

In addition, the predetermined time interval is preferably a time interval during which the orientations of all the first complexes present in the solution and all the second complexes present in the solution are completed.

When the predetermined time interval is determined in the above manner, it is not necessary to carry out a measurement once the first complexes and the second complexes are completely oriented, and therefore a measurement can be carried out within the shortest period of time.

In addition, the wavelength of the light radiated from the first light source is preferably a wavelength at which the maximum value of the light extinction amount derived from the long-axis direction of the metal nanorod appears.

When the wavelength of the light is determined in the above manner, a change in the absorbance of the solution caused by changes in the orientation direction of the first complexes and the orientation direction of the second complexes becomes the maximum, and high-accuracy measurement can be carried out.

In addition, the solution is preferably held in a container holding unit having a quadrangular prism-like shape, and, furthermore, the second light source preferably radiates the second light so that the second light is focused at a location at which the second light outgoes from the container holding unit.

When the second light is radiated so as to be focused at the location at which the second light outgoes from the container holding unit in the above manner, since the first complexes and the second complexes can be rotationally moved while pressed on a wall surface of the container holding unit, it becomes easy to control the orientations.

The solution is preferably held in the container holding unit having a quadrangular prism-like shape, and, furthermore, the third light source preferably radiates the third light so that the third light is focused at a location at which the third light outgoes from the container holding unit.

When the third light is radiated so as to be focused at the location at which the third light outgoes from the container holding unit in the above manner, since the first complexes and the second complexes can be rotationally moved while pressed on a wall surface of the container holding unit, it becomes easy to control the orientations.

In addition, the second light source preferably radiates the second light on the solution from a plurality of locations. The third light source preferably radiates the third light on the solution from a plurality of locations.

When the second light or the third light is radiated on the solution from a plurality of locations, it becomes easy to control the orientation directions of the first complexes and the second complexes present at various locations in the solution.

The detection unit may measure the absorbance of the first light by the solution as the light extinction amount. In addition, the detection unit may measure the scattered light of the first light by the solution as the light extinction amount.

The detection unit may measure any one of the absorbance and the scattered light as the light extinction amount. In a case in which only one of the absorbance and the scattered light is measured, the bio-molecule detecting device may have just a device for measuring any one, which prevents the device configuration from becoming complicated. In addition, both the absorbance and the scattered light may be measured. When both the absorbance and the scattered light are measured, higher-accuracy measurement can be carried out.

In addition, in order to achieve the above object, a bio-molecule detecting method according to the invention includes a step of, in a solution including first complexes having a substance that can specifically bond to a specific bio-molecule and a detection label exhibiting anisotropic light absorption characteristics and second complexes in which the bio-molecule is specifically bonded to the first complex through the substance, orienting the first complexes and the second complexes in at least two directions; a step of radiating first light having a linearly-polarized light component in a specific direction on the solution; a step of measuring a light extinction amount of the first light by the solution; and a step of carrying out detection or quantity determination of the bio-molecule based on the light extinction amount of the light measured using the detection unit, in which the first light is light having a wavelength at which the light extinction amount by the detection label is changed by a change in orientation directions of the first complexes and the second complexes.

When a measurement is carried out using the above method, a detection subject substance can be measured at high sensitivity with a simple configuration.

According to the invention, since a solid phase that fixes antigens, antibodies and the like to a wall surface is not used, a reaction is fast, and high-sensitivity bio-molecule detection can be carried out.

### BRIEF DESCRIPTION OF THE DRAWINGS

FIG. 1 is a schematic view illustrating the overview of an antigen-antibody reaction in a bio-molecule detecting device according to Embodiment 1.

FIG. 2A is a schematic view of a free molecule, and FIG. 2B is a schematic view of a binding molecule.

FIG. 3 is a graph illustrating the absorbance characteristics of a nanorod.

FIG. 4A is a view illustrating a case in which the vibration direction of light and the long-axis direction of the nanorod become parallel, and FIG. 4B is a view illustrating a case in which the vibration direction of light and the long-axis direction of the nanorod become vertical.

FIG. 5A is a perspective view of an appearance of the bio-molecule detecting device according to Embodiment 1, and FIG. 5B is a view of the bio-molecule detecting device according to Embodiment 1 with an access unit open.

FIG. 6 is a block diagram illustrating the principal configuration of the bio-molecule detecting device according to Embodiment 1.

FIG. 7 is a schematic view of the switching of the radiation direction of orientation control light radiated from an orientation control light source unit seen from the top surface.

FIG. 8A is a schematic view expressing the relationship between the radiation direction of the orientation control light and the orientation directions of a plurality of molecules, and FIG. 8B is a schematic view expressing the relationship between the radiation direction of the orientation control light and the orientation directions of a plurality of molecules in another case.

FIG. 9A is a view drawing the radiation direction of the orientation control light, the orientation direction of the free molecule, and the orientation direction of the binding molecule,

FIG. 9B is a view drawing the action of the free molecule and the action of the binding molecule in a case in which the radiation direction of the orientation control light is switched, and FIG. 9C is a schematic view drawing a case in which the radiation direction of the orientation control light is switched, and the free molecule and the binding molecule are completely oriented.

FIG. 10A is a view drawing the relationship between the oriented free molecule, the oriented binding molecule and the vibration direction of light, and FIG. 10B is a view drawing the relationship between the free molecule oriented in another direction, the binding molecule oriented in another direction and the vibration direction of light.

FIG. 11 is a graph expressing a change in absorbance caused by a change in the orientations of the nanorods.

FIG. 12 is a schematic view expressing the detailed configuration of a light-receiving unit in the bio-molecule detecting device according to Embodiment 1.

FIG. 13 is a view schematically expressing a flow from the preparation to disposal of a specimen.

FIG. 14 includes graphs expressing a cycle of an orientation control signal and a change of the absorbance of light having a wavelength of 905 nm over time by the solution in the bio-molecule detecting device according to Embodiment 1.

FIG. 15 is a graph illustrating the orientation control signal over a plurality of cycles in the bio-molecule detecting device according to Embodiment 1.

FIG. 16 is a schematic view illustrating the overview of an antigen-antibody reaction in a bio-molecule detecting device according to Embodiment 2.

FIG. 17 is a top view of two kinds of binding molecules used in Embodiment 2.

FIG. 18 is a graph illustrating the light absorption characteristics of two kinds of nanorods used in Embodiment 2.

FIG. 19 is a block diagram illustrating the principal configuration of the bio-molecule detecting device according to Embodiment 2.

FIG. 20 is a schematic view expressing the detailed configuration of a light-receiving unit in the bio-molecule detecting device according to Embodiment 2.

FIG. 21 is a graph expressing a change in absorbance caused by a change in the orientations of two kinds of the nanorods used in Embodiment 2.

FIG. 22A is a graph expressing a change of the absorbance of light having a wavelength of 905 nm over time by the solution, and FIG. 22B is a graph expressing a change of the absorbance of light having a wavelength of 1.1 μm over time by the solution.

FIG. 23A is a conceptual view expressing the orientation direction of the nanorod and the vibration direction of absorbance measurement light in a case in which the orientation control light is radiated from one side. FIG. 23B is a conceptual view expressing the orientation direction of the nanorod and the vibration direction of the absorbance measurement light in a case in which the orientation control light is radiated from the other side.

FIG. 24A is a block diagram illustrating the principal configuration of a bio-molecule detecting device according to Embodiment 3. FIG. 24B is a view expressing the positional relationship among a light source unit, the orientation control light source unit and the light-receiving unit of the bio-molecule detecting device according to Embodiment 3.

FIG. 25A is a conceptual view expressing the relationship between the orientation direction of one nanorod and the vibration direction of the absorbance measurement light.

FIG. 25B is a conceptual view expressing the relationship between the orientation direction of another nanorod and the vibration direction of the absorbance measurement light.

FIG. 26 includes graphs expressing changes in absorbance caused by changes in the orientation directions of the nanorods.

FIGS. 27A to 27C are views expressing the orientations of the nanorod with respect to a change in the vibration direction of the orientation control light.

FIG. 28 is a view illustrating a case in which the orientation control light is radiated on multiple points on a reagent cup.

FIG. 29 is a view illustrating the structure of an orientation control light source unit for entering the orientation control light on multiple points.

FIG. 30 is a view illustrating an example of an optical system for entering the orientation control light on multiple points.

FIG. 31 is a view illustrating another example of an optical system for entering the orientation control light on multiple points.

FIG. 32 is a view illustrating a micro lens array.

FIG. 33 is a view illustrating an example of the shape of the reagent cup.

FIG. 34 is a view illustrating the location of the focus of the orientation control light with respect to the reagent cup.

FIG. 35 is a view illustrating an example in which an absorbance component synchronized to the frequency of the orientation control signal is detected.

FIG. 36 is a graph illustrating calibration curve data with respect to the concentrations of three kinds of binding molecules and the lock-in amplifying output with respect to the frequency of the orientation control signal

### DESCRIPTION OF THE PREFERRED EMBODIMENTS

Hereinafter, embodiments of the invention will be described with reference to the accompanying drawings.

### Embodiment 1

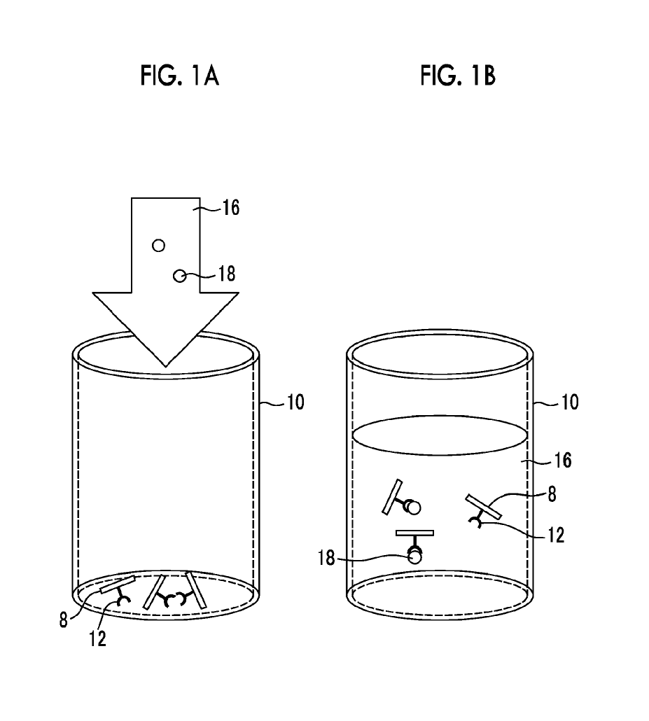

In Embodiment 1, one kind of antibody is used, and a specific kind of antigen, which is a detection subject substance in a homogenous solution, is detected. FIGS. 1A and 1B are schematic views illustrating the overview of an antigen-antibody reaction in a bio-molecule detecting device 100 according to Embodiment 1 of the invention. The antigen-antibody reaction in a liquid will be described using FIGS. 1A and 1B. In FIG. 1A, dried antibodies 12 are fed into a cylindrical reagent cup 10. The antibodies 12 are bonded to nanorods 8. The nanorod refers to a columnar nano-sized fine particle.

In the present embodiment, a specimen is blood plasma 16 separated from whole blood. When the blood plasma 16 is injected into and stirred in the reagent container 10, in a case in which antigens 18 that specifically bond to the antibodies 12 are present in the blood plasma 16, antigen-antibody reactions are caused between the antibodies 12 and the antigens 18, and the antibodies 18 are specifically bonded to the antigens 12 as illustrated in FIG. 1B. Since a sufficiently large amount of the antibodies 12 are fed with respect to the antigens 18, some of the antibodies 12 remain in a blood plasma solution without causing an antigen-antibody reaction. Hereinafter, a complex, in which the antibody 12, the antigen 18 and the nanorod 8 are bonded by the antigen-antibody reaction, will be called a binding molecule. In addition, a complex of the antibody 12 and the nanorod 8, which is not bonded to the antigen 18, will be called a free molecule. When the free molecules are mixed with the blood plasma 16, after a certain period of time elapses, a blood plasma solution, in which the binding molecules and the free molecules are present in a mixed state, is formed. Meanwhile, components other than the antigens 18 are also present in the blood plasma, but components other than the antigens 18 will not be illustrated in FIGS. 1A and 1B in order to simplify the description.

The bio-molecule detecting device 100 carries out the detection and quantity determination of the antigens 18 by radiating light on the solution, in which the binding molecules and the free molecules are present in a mixed state, and measuring an absorbance by the solution, particularly, an absorbance by the nanorods 8. Here, the nanorods 8 may be associated with the free molecules or the binding molecules. Since the free molecules and the binding molecules are present in a mixed state in the solution, the absorbance of the solution is the sum value of the absorbance of all the nanorods 8 present in the solution. Therefore, it is difficult to compute the extent of contribution of the nanorods 8 associated with the binding molecules, which include the antigens 18, to the absorbance. Therefore, the bio-molecule detecting device 100 measures the absorbance of the solution using the fact that the free molecules and the binding molecules have different degrees of ease of movement in the solution and the fact that the relationship between the orientation of the nanorods associated with the free molecules and the binding molecules in the long-axis direction and the vibration direction of light has an influence on the absorbance, and carries out the detection and quantity determination of the antigens 18. Specifically, the free molecules and the binding molecules are oriented, and the extent of contribution of the binding molecules to the absorbance in the absorbance of the entire solution is computed from the difference between a change in the absorbance of the free molecules over time and a change in the absorbance of the binding molecules over time, which are caused by the switching of the orientation direction. In addition, the detection and quantity determination of the antigens 18 are carried out based on the computed absorbance (extent of contribution) of the binding molecules.

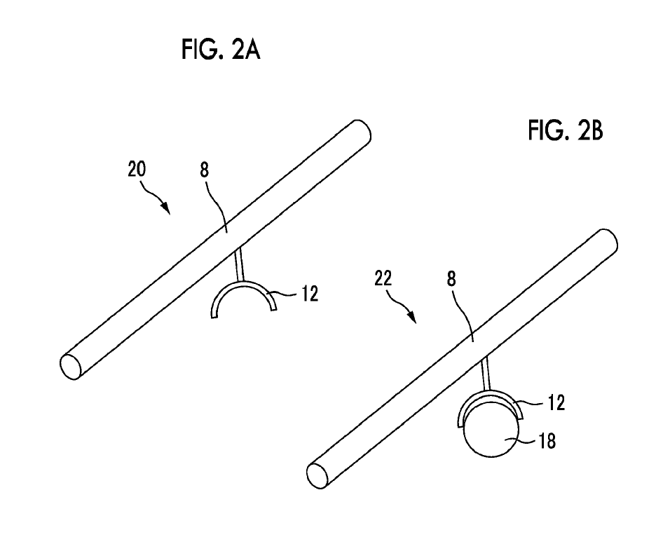

In the bio-molecule detecting device 100, in order to describe the principle of computing the extent of contribution of the binding molecules to the absorbance and the extent of contribution of the free molecules to the absorbance, the structure of the free molecule and the binding molecule used in the bio-molecule detecting device 100 will be described using FIGS. 2A and 2B. FIG. 2A expresses a schematic view of a free molecule 20. The free molecule 20 has the antibody 12 and the nanorod 8.

The nanorod 8 and the antibody 12 are bonded to each other. The nanorod 8 and the antibody 12 can be bonded using a well-known arbitrary method. For example, the nanorod and the antibody can be bonded by mixing an avidin gold-labeled nanorod and a biotinylated antibody. There is another method in which an antibody is bonded to a gold nanorod through protein A using the physical adsorption of protein A. Specifically, first, protein A is physically adsorbed to the gold nanorod, and, subsequently, the antibody is adsorbed. Since it is known that, generally, metals easily adsorb protein, a protein A solution is added to an untreated gold nanorod solution, and idled for approximately one hour in order to physically adsorb protein A to the gold nanorod. After one hour, when unadsorbed gold nanorods and unadsorbed protein A are filtered, separated using a spin filter, and gold nanorods, to which protein A are adsorbed, are obtained. Subsequently, antibodies are added to the gold nanorod solution, to which protein A is adsorbed, and idled for approximately one hour. After one hour, when unadsorbed gold nanorods and unadsorbed antibodies are filtered, separated using a spin filter, and gold nanorods, to which the antibodies are bonded, are obtained. Here, protein A refers to a protein that accounts for 5% of the cell wall component of staphylococcus aureus. Protein A specifically bonds to the antibody.

The antibody 12 is a substance that specifically bonds to the antigen 18, and is bonded to the nanorod 8. As the antibody 12, an antibody that specifically bonds to a detection subject substance that a user of the bio-molecule detecting device 100 wishes to detect is used.

In the embodiment, blood plasma separated from whole blood is used as the specimen, and an anti-PSA antibody is used as the antibody 12 that specifically bonds to the detection subject substance. Therefore, prostate specific antigen (PSA) is detected as the antigen 18, which is the detection subject substance.

The nanorod 8 has different lengths in the short-axis direction and in the long-axis direction as illustrated in FIG. 2A, and has an aspect ratio (long-axis length/short-axis length) of larger than 1 and a long and thin columnar shape. The nanorod is a fine metal particle.

Not only the absorbance exhibited by the free molecules 20 but also the absorbance exhibited by the binding molecules 22 are mainly influenced by the light absorption by the nanorods 8. Therefore, the degree of a light absorption phenomenon by the antibodies 12 or the antigens 18 is as small as ignorable compared to the light absorption by the nanorods 8.

In order to describe the absorption spectrum of the nanorods 8, first, the light absorption characteristics of fine metal particles will be described. It is known that, generally, when light is radiated on fine metal particles dispersed in a solution, light having a specific wavelength (plasmon resonance wavelength) resonates with metal plasmon so as to be absorbed. This is called localized surface plasmon resonance. The plasmon resonance wavelength in the localized surface plasm on resonance differs depending on the structures, such as kind, shape and array, of the fine metal particles. For example, in a case in which fine spherical gold particles are dispersed in water, the plasmon resonance wavelength becomes approximately 530 nm.

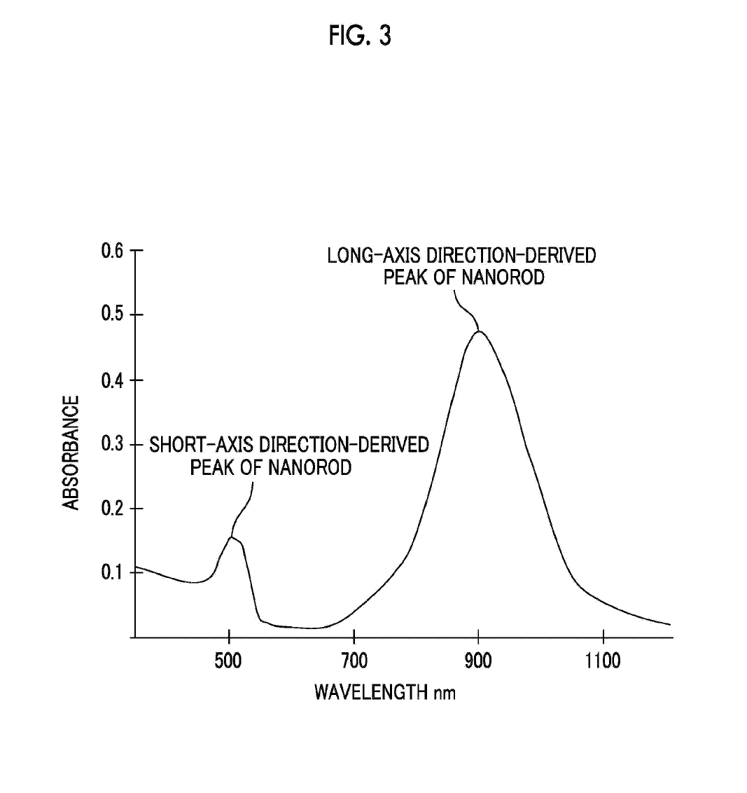

Unlike the case of a spherical fine metal particle, the plasmon resonance wavelength in the short-axis direction and the plasmon resonance wavelength in the long-axis direction are different in the nanorod, which is a columnar fine metal particle, and an absorption spectrum having two peaks is obtained (the schematic view is illustrated in FIG. 3). The peak located in the vicinity of a wavelength of 500 nm in the absorption spectrum is caused by the plasmon resonance in the short-axis direction of the nanorod. In addition, the peak in the vicinity of a wavelength of 900 nm is caused by plasmon resonance in the long-axis direction of the nanorod.

It is known that, when the aspect ratio of the nanorod increases, that is, the shape of the nanorod becomes thinner and longer, the plasmon resonance wavelength derived from the long-axis direction of the nanorod shifts toward the long wavelength side. In the embodiment, a gold nanorod having a short axis of 10 nm and a long axis of 50 nm is used. In the gold nanorod, the plasmon resonance wavelength derived from the long-axis direction becomes approximately 900 nm.

The gold nanorod adsorbs or binds a low-molecular compound or a high-molecular compound to the surface of the nanorod as a protective agent, whereby the fine metal particles are stably dispersed in the solvent without being agglomerated.

FIG. 2B expresses a schematic view of the binding molecule 22. The binding molecule 22 has the antibody 12, the nanorod 8 and the antigen 18. In the binding molecule 22, the antibody 12 is bonded to the antigen 18.

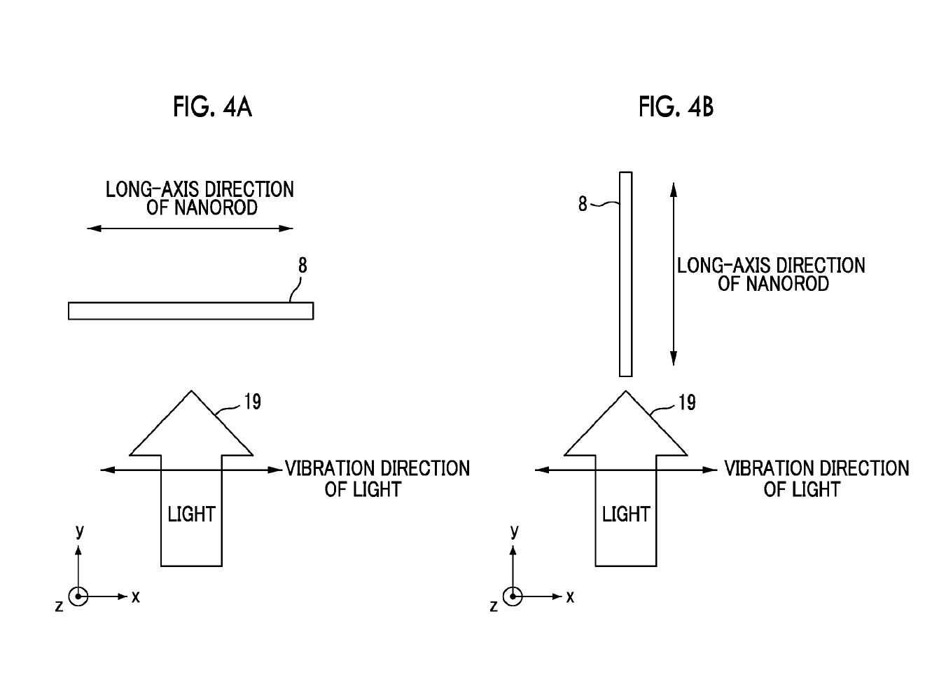

In a case in which light is radiated on the nanorod 8, the relationship between the vibration direction of light and the long-axis direction of the nanorod 8 has an influence on the absorbance of light by the nanorod 8. Light is a kind of electromagnetic wave; however, here, “the vibration direction of light” refers to the vibration direction of an electric field. In the embodiment, as illustrated in FIGS. 4A and 4B, the description will be made using a case in which linearly-polarized light 19 is radiated on the nanorod 8 as an example. Here, the linearly-polarized light refers to light having a constant vibration direction and a stationary polarization plane. In the cases of FIGS. 4A and 4B, the linearly-polarized light 19 travels toward the positive direction of the y axis while vibrating in the xy plane. When the motion of the light 19 is considered separately in the traveling direction and in the vibration direction, the positive direction of the y axis becomes the traveling direction, and the x-axis direction becomes the vibration direction. A plane on which the traveling direction and vibration direction of the linearly-polarized light are present (here, the xy plane) is called the polarization plane. In addition, the vibration direction of the linearly-polarized light is called a polarization axis. In a case in which the vibration direction of the linearly-polarized light 19 is parallel to the long-axis direction of the nanorod 8 (FIG. 4A), the absorbance derived from the long-axis direction of the nanorod 8 becomes the maximum. In a case in which the vibration direction of the linearly-polarized light 19 and the long-axis direction of the nanorod 8 are vertical to each other (FIG. 4B), the absorbance derived from the long-axis direction of the nanorod 8 becomes the minimum. That is, the orientations of the nanorods 8 in the solution have an influence on the absorbance by the nanorods 8.

As such, the relationship between the long-axis direction of the nanorod and the vibration direction of light has an influence on the absorbance of the nanorod, but the relationship between the long-axis direction of the nanorod and the vibration direction of light are the same for the nanorods 8 associated with the free molecules 20 and the nanorods 8 associated with the binding molecules 22.

In the solution, the free molecules 20 and the binding molecules 22 are in motion, and the orientations of the free molecules 20 and the binding molecules 22 in the solution, that is, the orientations of the nanorods 8 in both molecules have an influence on the absorbance of the solution. Therefore, the motions of the free molecules 20 and the binding molecules 22 in the solution will be studied. The free molecules 20 and the binding molecules 22 are in the irregular Brownian motion in the solution, and move and rotate in the solution. Therefore, the orientations of the free molecules 20 and the orientations of the binding molecules 22 are diverse.

It is known that the Brownian motion of the molecules in the solution is influenced by the absolute temperature, the volumes or masses of the molecules, the viscosity of a solvent, and the like. The binding molecule 22 has a larger volume and a larger mass than the free molecule 20 by the antigen 18, and cannot easily carry out the Brownian motion in the solution. A method, in which the binding molecule 22 is detected from a change in the Brownian motion using the fact that there is a difference in the degree of ease of the Brownian motion in the solution between the free molecule 20 and the binding molecule 22, is known; however, since a random motion called the Brownian motion is used, there is a limitation on the detection sensitivity.

Therefore, the bio-molecule detecting device 100 controls the orientations of the free molecules 20 and the orientations of the binding molecules 22 in the solution using a laser called orientation control light. When a laser is radiated on the free molecules 20 and the binding molecules 22 present in the solution, an external force is applied mainly to the nanorods 8, and the free molecules 20 and the binding molecules 22, which have been in a random motion in the solution, are oriented in a specific direction. Meanwhile, a state in which a plurality of molecules receives an external force and is all oriented in a specific direction as described above will be expressed as a state in which “the orientation is completed”. Since there is a difference in the degree of ease of the rotary motion in the solution between the free molecule 20 and the binding molecule 22 due to the difference in the volume or mass, for example, even in a case in which the orientations of the molecules in the solution are controlled using the laser, there is a difference in the necessary time, during which the laser is radiated and the orientation is completed, between the free molecules 20 and the binding molecules 22. The bio-molecule detecting device 100 separates the absorbance by the binding molecules from the absorbance of the solution, and detects bio-molecules using the difference in the degree of ease of rotary motion. More specifically, in the embodiment, bio-molecules are detected using the difference in the necessary time for the free molecules and the binding molecules to be completely oriented. The bio-molecule detecting device 100 causes a difference between the changing rate of the absorbance by the free molecules 20 and the changing rate of the absorbance by the binding molecules 22 using the difference between the necessary time for the free molecules 20 to be completely oriented and the necessary time for the binding molecules 22 to be completely oriented, and computes the extent of contribution by the binding molecules 22 in the absorbance of the solution.

Next, the configuration of the bio-molecule detecting device 100 according to Embodiment 1 of the invention will be described.

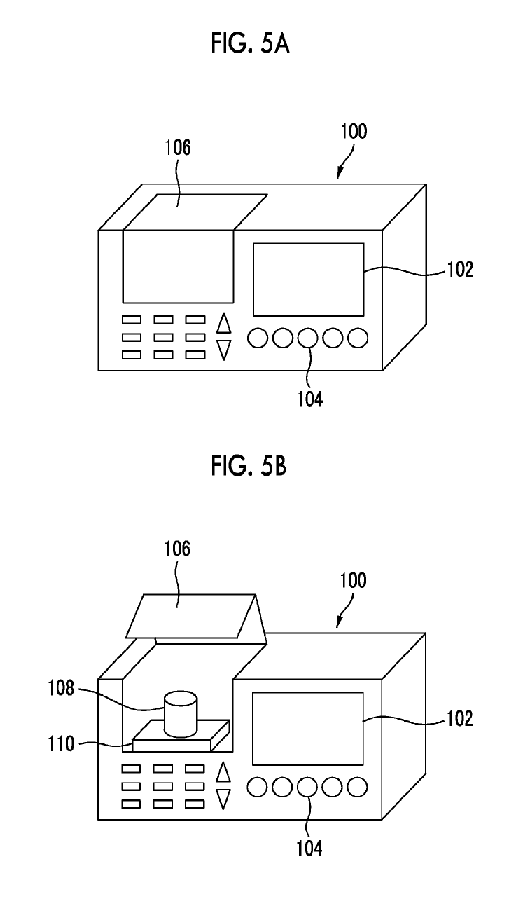

FIG. 5A is a perspective view of an appearance of the bio-molecule detecting device 100. There are a display unit 102, a user input unit 104 and an access unit 106 on a side surface of the bio-molecule detecting device 100. The display unit 102 displays measurement results and the like. In the user input unit 104, setting of modes, input of specimen information, and the like are carried out. The access unit 106 is configured to have an openable lid, which is opened when setting a specimen and is closed during measurement. This configuration prevents external light from influencing measurement.

FIG. 5B is a perspective view of an appearance of the bio-molecule detecting device 100 in a case in which the access unit 106 is opened. When the access unit 106 is opened, there are a reagent cup 108 and a holding table 110 in the bio-molecule detecting device 100. The reagent cup 108 is held by the holding table 110, and is attachable to and detachable from the holding table 110. The reagent cup 108 is a columnar container to which a solution is fed. A user injects a specimen into the reagent cup 108, closes the lid, and carries out a measurement. Although not illustrated, there are a reagent tank and a dispensing unit in the bio-molecule detecting device 100, and, when a measurement begins, the dispensing unit sucks up a reagent (for example, the antibody or the nanorod) from the reagent tank, and dispenses the reagent into the reagent cup 108.

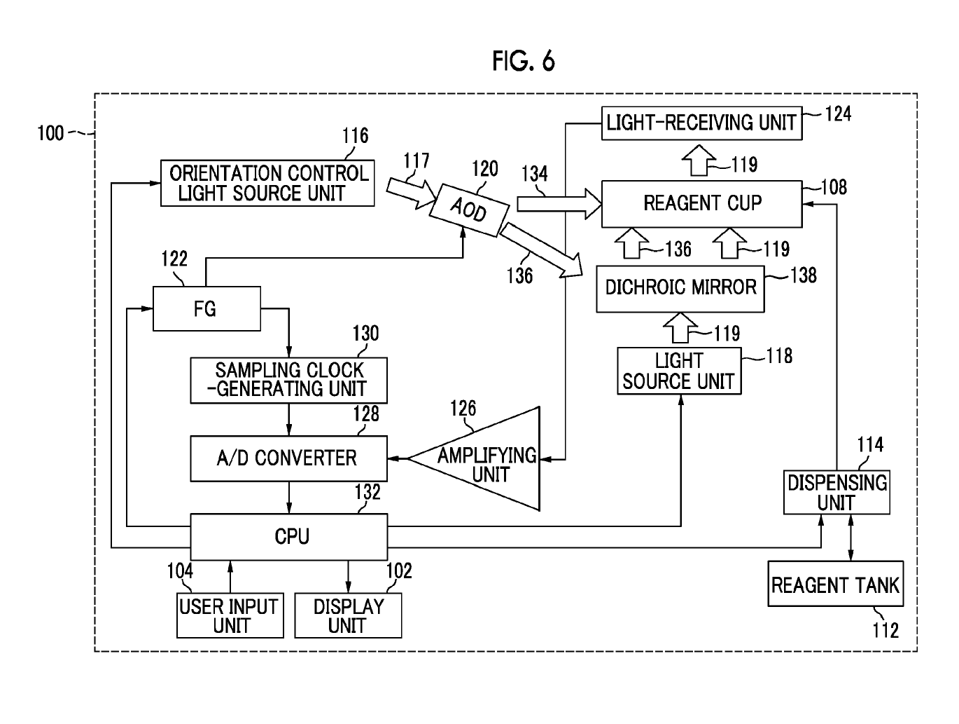

FIG. 6 is a function block diagram for explaining the principal configuration of the bio-molecule detecting device 100. The bio-molecule detecting device 100 has the display unit 102, the user input unit 104, the reagent cup 108, a reagent tank 112, a dispensing unit 114, an orientation control light source unit 116, a light source unit 118, an acousto optic deflector (AOD) 120, a function generator (hereinafter, indicated by FG) 122, a light-receiving unit 124, an amplifying unit 126, an A/D converter 128, a sampling clock-generating unit 130, a CPU 132 and a dichroic mirror 138.

The reagent cup 108 is a container in which the reagent stored in the reagent tank 112 and a specimen sampled from a patient or the like are reacted. The reagent cup 108 has a columnar shape. The reagent cup 108 is attachable to and detachable from the bio-molecule detecting device 100. The capacity of the reagent cup 108 is approximately 120 pt.

The reagent tank 112 is a tank in which a plurality of kinds of reagents is fed into respectively separate containers and stored. Here, the reagent refers to a substance relating to measurement in the bio-molecule measuring device 100, such as an antigen, an antibody, a nanorod, a complex thereof, or the like. In the embodiment, the free molecules 20 are stored in the reagent tank 112.

The dispensing unit 114 is configured of a detachable pipette or aspirator. The dispensing unit 114 obeys an order from the CPU 132, sucks a reagent to be used in measurement from the reagent tank 112 using the pipette, and dispenses into the reagent cup 108.

The orientation control light source unit 116 radiates orientation control light 117 toward AOD 120, and applies an external force to the free molecules and the binding molecules present in the solution in the reagent cup 108, thereby controlling the orientations of the molecules. As the orientation control light 117, a laser having a wavelength of 1000 nm and an output of 700 mW is used. The orientation control light 117 has a beam width large enough to radiate the entire solution in the reagent cup 108.

The light source unit 118 radiates light for absorbance measurement, which is linearly polarized using a polarizer included in the light source unit, (hereinafter, refer to the absorbance measurement light 119) toward the light-receiving unit 124 from a side surface of the reagent cup 108 with the reagent cup 108 interposed therebetween. As the absorbance measurement light 119, light having a wavelength of 905 nm and an output of 0.1 mW is used. Meanwhile, as the absorbance measurement light 119, light having a wavelength, at which a peak derived from the long-axis direction of the nanorod 8 is generated, is desirably used, and, here, light having a wavelength of 905 nm is used in consideration of the easy procurement of a light source.

AOD 120 switches the traveling direction of the entered light by changing the refractive index of the inside based on an input voltage using an acousto-optical effect. AOD 120 changes the refractive index of the inside based on a voltage displayed by a voltage signal (hereinafter, this signal will be referred to as orientation control signal) output from FG 122 so as to switch the traveling direction of the orientation control light 117. That is, the traveling direction of the orientation control light 117 is determined by the voltage signal generated by FG 122.

FG 122 is a device that can generate voltage signals having a variety of frequencies and waveforms, receives an order output from CPU 132, and outputs respectively different voltage signals to AOD 120 and the sampling clock-generating unit 130.

CPU 132 comprehensively controls the operations of the respective units in the bio-molecule detecting device 100, and carries out the computation and the like of measurement results. CPU 132 controls timing, at which AOD 120 switches the radiation direction of the orientation control light 117, by designating the orientation control signal output by FG 122.

The light-receiving unit 124 is provided opposite to the light source unit 118 with the reagent cup 108 interposed therebetween. The light-receiving unit 124 receives the absorbance measurement light 119, which has transmitted through the reagent cup 108, and converts into an analog electric signal, thereby outputting to the amplifying unit 126.

The amplifying unit 126 amplifies analog data output from the light-receiving unit 124, and outputs to the A/D converter 128.

The sampling clock-generating unit 130 inputs to the A/D converter 128 a sampling clock that designates the timing, at which the A/D converter 128 samples the analog data, based on the voltage signal input from FG 122.

The A/D converter 128 carries out the sampling of the analog data output from the amplifying unit 126 based on a sampling clock output from the sampling clock-generating unit 130, converts the analog data into digital data, and outputs to CPU 132.

CPU 132 carries out the computation of the absorbance of the solution with respect to the absorbance measurement light 119 and the quantity determination of a detection subject substance based on the digital data output from the A/D converter 128, and outputs results to the display unit 102. In addition, CPU 132 carries out the instruction and ordering of the operations of the orientation control light source unit 116, the light source unit 118, the dispensing unit 114 and FG 122 based on a signal input from the user input unit 104. Specifically, CPU 132 carries out the ordering of the ON and OFF of the orientation control light source unit 116 and the light source unit 118. In addition, CPU carries out the ordering of designating a reagent to use and starting a dispensing operation with respect to the dispensing unit 114. Furthermore, CPU carries out the ordering of instructing and outputting a signal waveform to output with respect to FG 122.

The dichroic mirror 138 is a mirror that radiates light having a specific wavelength and transmits light having other wavelengths. The dichroic mirror 138 reflects the orientation control light 117, and transmits the absorbance measurement light 119.

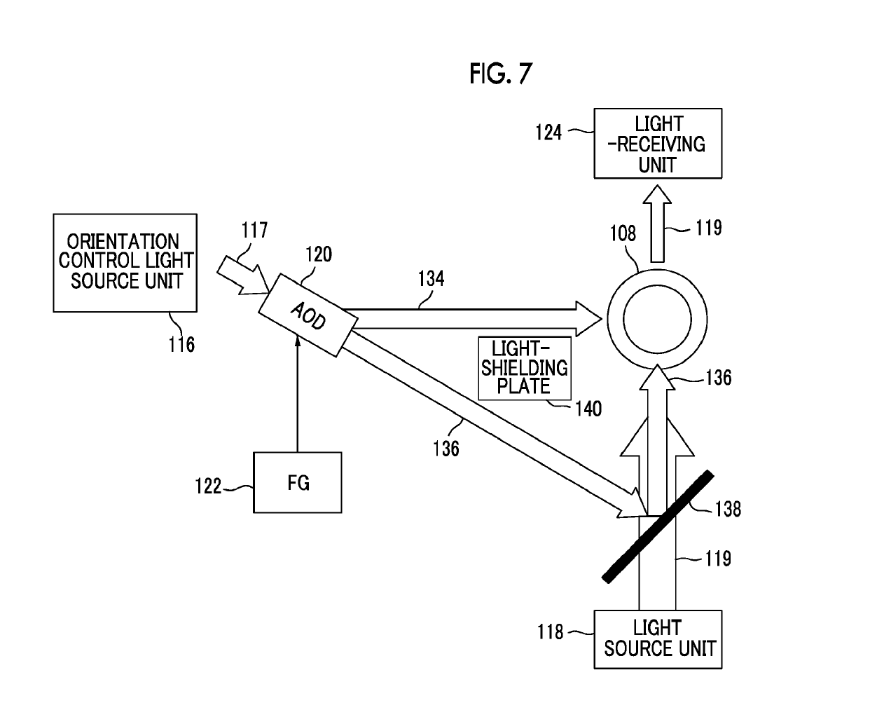

FIG. 7 is a schematic view of the switching of the radiation direction of orientation control light 117 radiated from the orientation control light source unit 116 seen from the top of the bio-molecule detecting device 100. The switching of the radiation direction of the orientation control light 117 with respect to the reagent cup 108 will be described in detail using FIG. 7.

The orientation control light 117 radiated from the orientation control light source unit 116 is radiated on the reagent cup 108 through AOD 120.

In a case in which an orientation control signal of 5 V is input from FG 122, AOD 120 switches the traveling direction of the orientation control light 117. In this case, the orientation control light 117 travels in the direction of the orientation control light 134, and enters the reagent cup 108 through a side surface thereof.

In a case in which an orientation control signal of 0 V is input from FG 122, AOD 120 passes the orientation control light 117, and make the orientation control light travel in the direction of the orientation control light 136. The orientation control light 136 is reflected by the dichroic mirror 138, travels in a direction vertical to the traveling direction of the orientation control light 134, and enters the reagent cup 108 through a side surface thereof. When the reagent cup 108 seen from the top is compared to a clock dial plate, the orientation control light 134 enters from the 9 o'clock direction, and travels in the 3 o'clock direction. The orientation control light 136 enters from the 6 o'clock direction, and travels in the 12 o' clock direction.

The dichroic mirror 138 reflects only light having a wavelength, which has been used as the orientation control light 117, and transmits light having other wavelengths. The absorbance measurement light 119 radiated from the light source unit 118 transmits through the dichroic mirror 138, travels in the same direction as the orientation control light 136 reflected at the dichroic mirror 138, and enters the reagent cup 108 through a side surface thereof.

In the above configuration, the bio-molecule detecting device 100 can switch the radiation direction of the orientation control light 117 on the reagent cup 108 between two directions having a 90-degree angular difference. A light-shielding plate 140 is provided between AOD 120 and the reagent cup 108 so that the orientation control light 117 traveling in directions other than the traveling direction of the orientation control light 134 and the traveling direction of the orientation control light 136 is not radiated on the reagent cup 108. In addition, even in a case in which the orientation control light 117 travels in the traveling direction of the orientation control light 134 or in the traveling direction of the orientation control light 136, the orientation control light enters from a side surface of the columnar reagent cup 108. Since the reagent cup 108 has a columnar shape, even when the traveling direction of the orientation control light 117 is switched, the shape of the side surface of the reagent cup 108, into which the orientation control light 117 enters, is the same. Therefore, the influence of the shape of the reagent cup 108 becomes the same regardless of the traveling direction of the orientation control light 117.

The orientation control light source unit 116 orients the free molecules 20 and the binding molecules 22 in specific directions by applying external forces, such as the orientation control light 134 and 136, to the free molecules 20 and the binding molecules 22 through AOD 120. The external force caused by the orientation control light 134 and 136 is generated as a counteraction when the light hits the free molecules 20 and the binding molecules 22 so as to be scattered. As illustrated in FIG. 2, the free molecule 20 and the binding molecule 22 form anisotropic molecules extending in the long-axis direction of the nanorod 8 in terms of the shape of the entire molecules since the nanorod 8, which accounts for the principle portions, has a long and narrow shape. Therefore, in a case in which the orientation control light 134 and 136 hit the free molecules 20 or the binding molecules 22, the free molecules 20 or the binding molecules 22 move rotationally so that the counteraction with respect to the orientation control light 134 and 136 decreases (the area hit by the orientation control light 134 and 136 becomes smaller). As a result, the orientations of the free molecules 20 and the binding molecules 22 (the orientations of the long axes of the nanorods 8) and the traveling directions of the orientation control light 134 and 136 become parallel. Since the free molecules and the binding molecules are energetically in the most stable state when the parallel relationship is formed, the rotational movement of the free molecules 20 and the binding molecules 22 stop at this point in time. In other words, when the orientation control light 134 and 136 are not radiated on the free molecules 20 and the binding molecules 22, the molecules are dispersed in random directions in the solution; however, when the orientation control light 134 is radiated, the free molecules 20 and the binding molecules 22 move rotationally, and stop at a location at which the long-axis directions of all the nanorods 8 are in the traveling direction of the orientation control light 134. Even in a case in which the orientation control light 136 is radiated, similarly, the free molecules 20 and the binding molecules 22 move rotationally, and stop at a location at which the long-axis directions of all the nanorods 8 are in the traveling direction of the orientation control light 136.

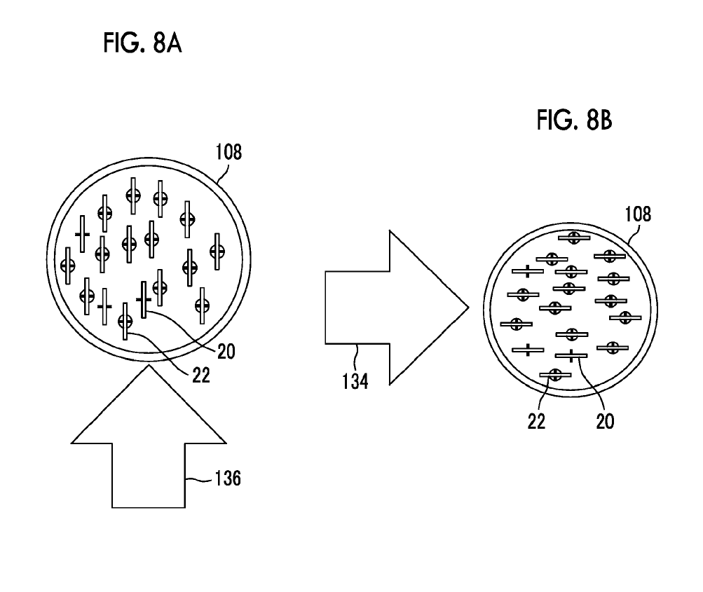

FIGS. 8A and 8B are schematic views expressing the relationship between the radiation direction of a laser and the orientation direction of the free molecules 20 or the binding molecules 22. FIGS. 8A and 8B are views seen from the top of the reagent cup 108.

FIG. 8A is a view illustrating a case in which the orientation control light 136 is radiated from a side surface of the reagent cup 108, and the free molecules 20 and the binding molecules 22 are both oriented in the same direction as the traveling direction of the orientation control light 136. As illustrated in the drawing, the free molecules 20 and the binding molecules 22 present in the solution, which are irradiated with the orientation control light 136, are all oriented in the same direction. That is, the long-axis directions of the nanorods 8 associated with the free molecules 20 and the long-axis direction of the nanorods 8 associated with the binding molecules 22 are in the same direction.

FIG. 8B is a view illustrating a case in which the orientation control light 134 traveling in a direction having a 90-degree angular difference from the orientation control light 136 illustrated in FIG. 8A is radiated from a side surface of the reagent cup 108 so that the free molecules 20 and the binding molecules 22 are oriented in the same direction as the traveling direction of the orientation control light 134. When the radiation direction of the orientation control light is switched by 90 degrees as from the orientation control light 136 to the orientation control light 134, the free molecules 20 oriented in the traveling direction of the orientation control light 136 (toward the long-axis directions of the nanorods) receive a force in a rotational movement direction. Similarly, the binding molecules 22 receive a force in a rotational movement direction when the radiation direction of the orientation control light is switched by 90 degrees. After that, when a sufficient amount of time elapses, the free molecules 20 and the binding molecules 22 are oriented in the radiation direction of the orientation control light 134, that is, toward the long-axis directions of the nanorods in the left and right direction of the paper. Even in this case, the long-axis directions of the nanorods 8 associated with the free molecules 20 and the long-axis direction of the nanorods 8 associated with the binding molecules 22 are in the same direction. When the radiation direction of the orientation control light is switched, and a sufficient amount of time elapses, the long-axis directions of the nanorods 8 associated with all the free molecules 20 and the long-axis direction of the nanorods 8 associated with all the binding molecules 22 are in the same direction, but there is a difference between the necessary time for the free molecules 20 to be completely oriented and the necessary time for the binding molecules 22 to be completely oriented.

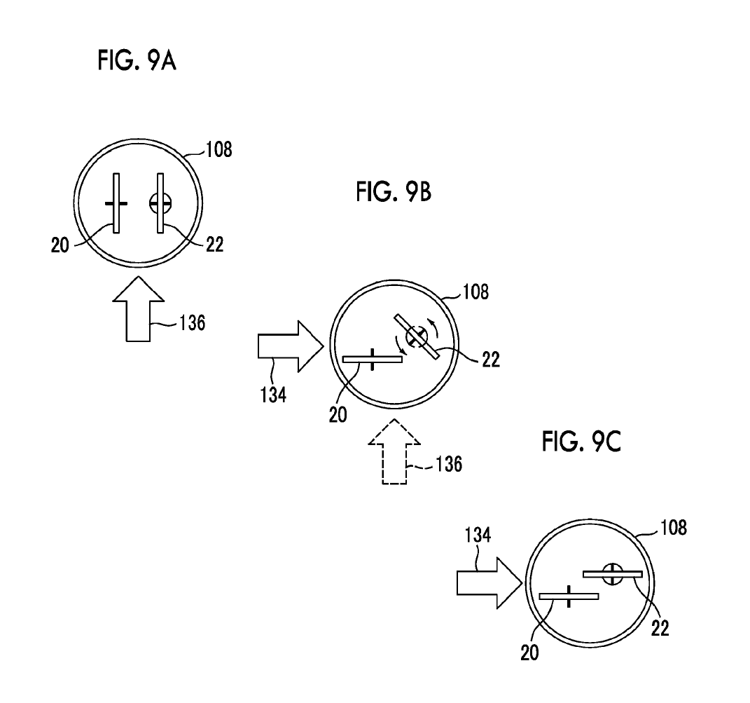

The actions of the free molecules 20 and the binding molecules 22 caused by the switching of the traveling direction of the orientation control light 117 radiated from the orientation control light source unit 116 will be described in detail using the schematic views of FIGS. 9A to 9C. Meanwhile, here, in order to make the description easily understandable, a case in which one free molecule 20 and one binding molecule 22 are present respectively in the reagent cup 108 will be used as an example in the description.

FIG. 9A is a view illustrating the orientation direction of the free molecule 20 and the orientation direction of the binding molecule 22 in a case in which AOD 120 passes the orientation control light 117 (a case in which the traveling direction of the orientation control light 117 does not change). When the orientation control light 136 travels upward from below the paper so as to enter the reagent cup 108, the free molecule 20 and the binding molecule 22 are oriented in an orientation in which the long-axis directions of the nanorods 8 associated with the respective molecules become parallel to the traveling direction of the orientation control light 136 (in this case, the up and down direction of the paper).

FIG. 9B is a view for explaining the actions of the free molecule 20 and the binding molecule 22 in a case in which AOD 120 switches the traveling direction of the orientation control light 117. When the orientation control light 134 travels from the left to right of the paper so as to enter the reagent cup 108, the free molecule 20 and the binding molecule 22 rotationally move so that the long-axis directions of the nanorods 8 associated with the respective molecules becomes the same direction as the traveling direction of the orientation control light 117. In this case, the free molecule 20 having a smaller volume and a smaller mass than the binding molecule 22 rotationally moves faster, and the necessary time for completing orientation is short. The binding molecule 22 completes the orientation later than the free molecule 20.

FIG. 9C is a view illustrating the orientation direction of the free molecule 20 and the orientation direction of the binding molecule 22 in a case in which AOD 120 switches the traveling direction of the orientation control light 117. When the orientation control light 134 travels from the left to right of the paper so as to enter the reagent cup 108, the free molecule 20 and the binding molecule 22 are oriented in an orientation in which the long-axis directions of the nanorods associated with the respective molecules become parallel to the traveling direction of the orientation control light 134 (in this case, the left and right direction of the paper).

In the above manner, the bio-molecule detecting device 100 can switch the orientation direction of the free molecules 20 and the orientation direction of the binding molecules 22 between two directions having a 90-degree angular difference.

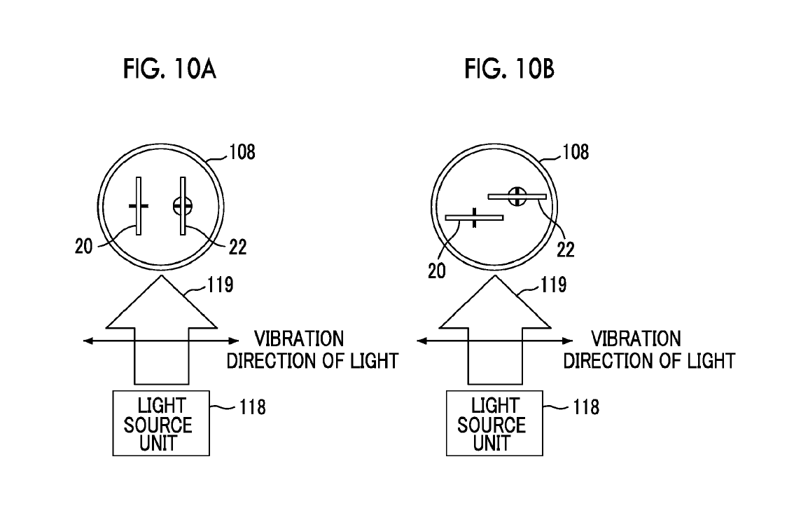

Next, the relationship between the respective orientation directions of the free molecule 20 and the binding molecule 22 and the absorbance measurement light 119 will be described using FIGS. 10A and 10B.

FIG. 10A is a schematic view illustrating the relationship between the respective orientation directions of the free molecule 20 and the binding molecule 22 and the vibration direction of the absorbance measurement light 119 in a case in which the output from FG 122 to AOD 120 is 0 V.

In a case in which the output from FG 122 to AOD 120 is 0 V, the vibration direction of the absorbance measurement light 119 and the long-axis direction of the nanorods 8 becomes vertical. In this case, the absorbance derived from the long-axis direction of the nanorod 8 associated with the free molecule 20 also becomes the minimum, and the absorbance derived from the long-axis direction of the nanorod 8 associated with the binding molecule 22 also becomes the minimum.

FIG. 10B is a schematic view illustrating the relationship between the respective orientation directions of the free molecule 20 and the binding molecule 22 and the vibration direction of the absorbance measurement light 119 in a case in which the output from FG 122 to AOD 120 is 5 V.

In a case in which the output from FG 122 to AOD 120 is 5 V, the vibration direction of the absorbance measurement light 119 and the long-axis direction of the nanorod 8 become parallel. In this case, the absorbance derived from the long-axis direction of the nanorod 8 associated with the free molecule 20 also becomes the maximum, and the absorbance derived from the long-axis direction of the nanorod 8 associated with the binding molecule 22 also becomes the maximum.

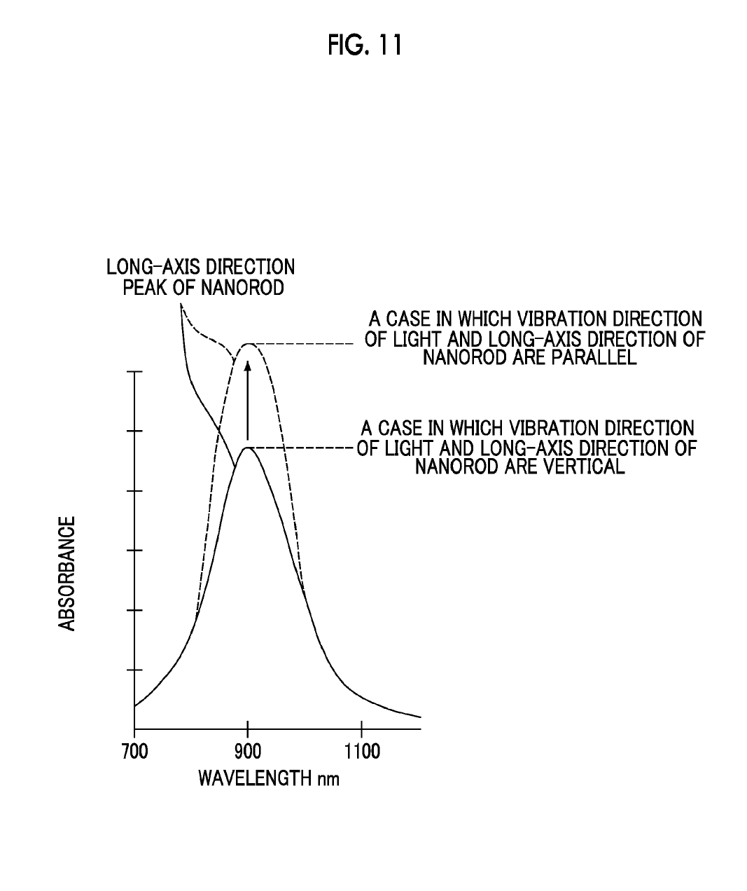

As such, the switching of the radiation direction of the orientation control light 117 using AOD 120, that is, the switching of the orientation directions of the free molecules 20 and the binding molecules 22 switches the absorbance derived from the long-axis direction of the nanorods 8 associated with the free molecules 20 or the binding molecules 22 between the maximum and the minimum. FIG. 11 is a graph illustrating a change in the absorbance caused by the switching of the orientation direction of the free molecules 20 and the binding molecules 22. In the case of the nanorods 8 used in the embodiment, the absorbance with respect to light having a wavelength of approximately 900 nm is changed by the relationship between the vibration direction of the absorbance measurement light 119 and the long-axis direction of the nanorod. The absorbance becomes the minimum in a case in which the vibration direction of the absorbance measurement light 119 and the long-axis direction of the nanorod is in a vertical relationship, and the absorbance becomes the maximum in a case in which the vibration direction of the absorbance measurement light 119 and the long-axis direction of the nanorod is in a parallel relationship. Here, the absorbance that is most significantly changed by the change in the orientation direction of the nanorod 8 is the absorbance with respect to light having a wavelength, at which a peak appears, that is, the absorbance with respect to light of 900 nm.

The orientation directions of the free molecules 20 and the binding molecules 22 are switched by the switching of the radiation direction of the orientation control light 117, but the free molecules 20 and the binding molecules 22 have different volumes and masses, and therefore the switching rates of the orientation with respect to the switching of the radiation direction of the orientation control light 117 are different. Since the free molecule 20 has a smaller volume and a smaller mass than the binding molecule 22, the free molecule changes the orientation direction faster than the binding molecule 22 with respect to the switching of the radiation direction of the orientation control light 117. That is, since the free molecules are completely oriented earlier than the binding molecules 22, the timing at which the absorbance per molecule becomes the maximum appears at an earlier stage than the binding molecule 22.

The bio-molecule detecting device 100 separates the extent of contribution of the free molecules 20 and the extent of contribution of the binding molecules 22 to the sum of the absorbance based on the change in the absorbance of the solution over time caused by the switching of the radiation direction of the orientation control light 117 using the fact that there is a difference between the timing at which the absorbance of the free molecule 20 changes and the timing at which the absorbance of the binding molecule 22 changes due to the switching of the radiation direction of the orientation control light 117.

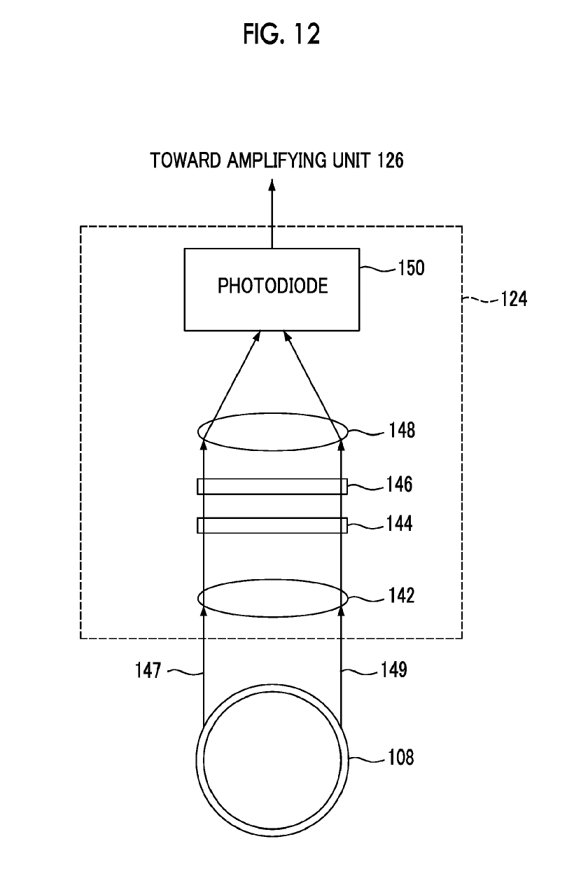

Subsequently, the detailed configuration of the light-receiving unit 124 will be described using FIG. 12. FIG. 12 is a schematic view expressing the detailed configuration of the light-receiving unit 124. The light-receiving unit 124 includes a lens 142, a filter 144, a polarizer 146, a lens 148 and a photodiode 150.

The light-receiving unit 124 receives the absorbance measurement light 119, which has transmitted through the reagent cup 108, from the bottom surface side of the reagent cup 108. The absorbance measurement light 119, which has transmitted through the free molecules 20 or the binding molecules 22 in the reagent cup 108, is collected using the lens 142, passes through the filter 144, the polarizer 146 and the lens 148, and enters the photodiode 150. In the drawing, the traveling direction of the light is indicated using a left end 147 and a right end 149 of the absorbance measurement light 119.

The filter 144 is a bandpass filter that cuts light having a wavelength other than the wavelength of the absorbance measurement light 119, and prevents light other than the absorbance measurement light 119, such as the orientation control light, from entering the photodiode 150.

The polarizer 146 only transmits light vibrating in the same direction as the vibration direction of the absorbance measurement light 119.

The photodiode 150 receives the absorbance measurement light 119 collected using the lens 148, and generates charges in accordance with the intensity of the absorbance measurement light 119 so as to output to the amplifying unit 126. In the above manner, the light-receiving unit 124 only receives the absorbance measurement light 119 which has transmitted through the inside of the reagent cup 108, and does not receive other light which causes noises.

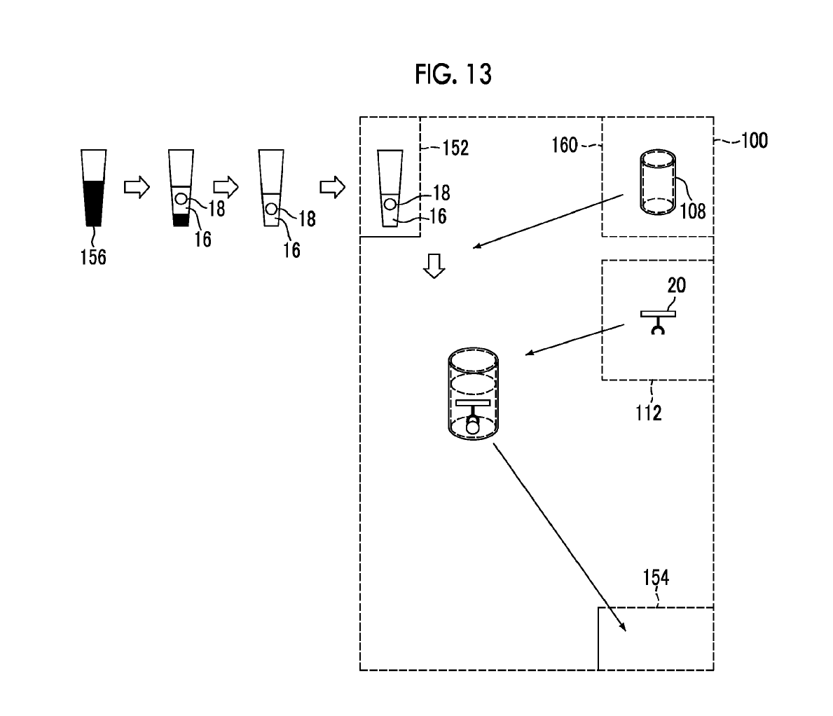

Subsequently, the operation of the bio-molecule detecting device 100 during a measurement will be described. FIG. 13 is a view schematically expressing the flow of the preparation to waste of a specimen.

In preparing for a measurement, first, 50 pt of whole blood 156 sampled from a patient is centrifugally separated, and blood plasma 16 is separated. The separated and extracted blood plasma 16 is set in a specimen setting unit 152 in the bio-molecule detecting device 100. The above operations are carried out by a user.

The bio-molecule detecting device 100 dispenses the blood plasma set in the specimen setting unit 152 into the unused reagent cup 108 stocked in a reagent cup-stocking unit 160. Subsequently, the bio-molecule detecting device 100 sucks up the free molecules 20 present in the reagent tank 112 using a pipette 158, and dispenses into the reagent cup 108. After injecting the blood plasma 16 and the free molecules 20 into the reagent cup 108, the bio-molecule detecting device 100 vibrates the reagent cup 108 using a built-in vortex mixer while adjusting the temperature to 37° C. so as to cause an antigen-antibody reaction. After that, the bio-molecule detecting device 100 carries out the radiation of the absorbance measurement light 119, the detection or quantity determination of the detection subject substance, and the like, and disposes the reagent cup 108 into a built-in trash box 154 after the completion of the measurement.

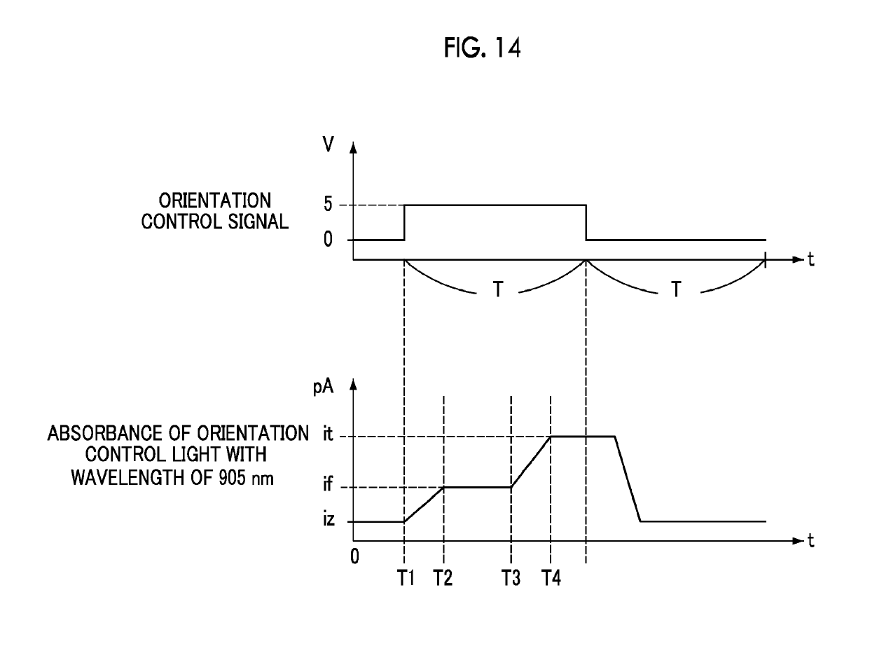

The change in the orientation control signal output by FG 122 during the measurement and the change in the absorbance of light having a wavelength of 905 nm, which is caused by the solution in the reagent cup, will be described using FIG. 14. FIG. 14 is a graph in which the voltage of the orientation control signal in the bio-molecule detecting device 100 or the absorbance of the orientation control light having a wavelength of 905 nm is expressed in the vertical axis, and the time t is expressed in the horizontal axis. Meanwhile, here, the graph for the absorbance of light having a wavelength of 905 nm is schematically illustrated in order to facilitate the description.

The orientation control signal output from FG 122 becomes 0 V before the measurement. Before the measurement, the orientation control light 117 is radiated on the solution in the reagent cup 108 so as to orient the free molecules 20 and the binding molecule 22 in the same direction. As the measurement begins, CPU 132 outputs an order of the beginning of the radiation of the absorbance measurement light 119 to the light source unit 118. In a case in which the orientation control signal is 0 V, the absorbance of the solution in the reagent cup 108 becomes a value of iz.

When the absorbance measurement light 119 is radiated toward the reagent cup 108, the nanorods 8 in the solution cause localized surface plasmon resonance, and absorb the absorbance measurement light 119. The absorbance measurement light 119 transmits through the solution while being weakened due to the absorption into the nanorods 8, and enters the photodiode 150 in the light-receiving unit 124. The absorbance iz of the absorbance measurement light 119 by the nanorods 8 in a case in which the orientation control signal is 0 V is measured from the original output of the absorbance measurement light 119, which has been radiated from the light source unit 118, and the output of the absorbance measurement light 119 received at the photodiode 150.

Subsequently, CPU 132 outputs an order of setting the orientation control signal to 5 V at a time T1. When the orientation control signal is set to 5 V, AOD 120 switches the radiation direction of the orientation control light 117 by 90 degrees. Following the switching of the radiation direction of the orientation control light 117, the orientation directions of the free molecules 20 and the binding molecules 22 present in the reagent cup 108 are switched by 90 degrees.

As the orientation direction of the free molecules 20 is switched, the switching of the orientation direction of the binding molecules 22 begins, and as the vibration direction of the absorbance measurement light 119 and the long-axis direction of the nanorod 8 approximate in the same direction, a fraction of the absorbance measurement light 119 and the nanorods 8 causing localized surface plasmon resonance increases, and the absorbance increases. Therefore, as the orientation direction of the free molecules 20 is switched, and the switching of the orientation direction of the binding molecules 22 begins, the absorbance of the solution with respect to light having a wavelength of 905 nm also increases from iz. In this case, since the orientation direction of the free molecules 20, which have a smaller volume and a smaller mass than the binding molecule 22, is switched faster, the absorbance of the free molecules 20 also changes faster.

In the free molecules 20 and the binding molecules 22, whose orientation directions are completely switched (here, the vibration direction of the absorbance measurement light 119 and the long-axis direction of the nanorods 8 become parallel), the absorbance of the absorbance measurement light 119 becomes the maximum. Since the orientation direction of the free molecules 20 is switched faster, when the orientation direction of all the free molecules 20 is completely switched at a time T2, the absorbance of light having a wavelength of 905 nm is saturated at a value of if

After that, as the orientation direction of the binding molecules 22 is switched, the graph of the absorbance also increases again at a time T3. When the orientation direction of all the binding molecules 22 is completely switched at a time T4, the absorbance of light having a wavelength of 905 nm is saturated at a value of it.

The output of the orientation control signal remains at 5 V for T seconds, and then becomes 0 V. This T seconds is set to at least a sufficient period of time for the absorbance of light having a wavelength of 905 nm to be saturated for the second time at the time T4. When the orientation control signal is switched from 5 V to 0 V, the absorbance of the light having a wavelength of 905 nm temporarily exhibits a value of it, and then decreases to a value of iz. The reason for the absorbance of light having a wavelength of 905 nm to become iz is that, since the orientation control signal is switched into 0 V, the vibration direction of the absorbance measurement light 119 and the long-axis direction of the nanorods 8 associated with both the free molecules 20 and the binding molecules 22 become vertical, and the absorbance of the free molecules 20 or the binding molecules 22 per molecule decreases. The reason for the absorbance of light having a wavelength of 905 nm to exhibit the value of it for a temporary period of time even in a state in which the orientation control signal becomes 0 V is that the switching timing of the orientation directions of the free molecules 20 and the binding molecules 22 is slower than the switching timing of the orientation control signal.

Here, the period of time for setting the orientation control signal to 0 V was set to T seconds, which is the same as the period of time during which the orientation control signal was set to 5 V. This is because, under a condition in which the output of the orientation control light 117 is constant, the necessary time for the orientation directions of the free molecules 20 and the binding molecules 22 in the solution to be completely switched is almost the same between a case in which the orientation control signal is set to 5 V from 0 V and a case in which the orientation control signal is set to 0 V from 5 V. A period of time, during which the orientation control signal is changed from 0 V to 5 V, the time elapses as long as T, the orientation control signal returns to 0 V, and the time elapses as long as T, is one cycle of the measurement in the bio-molecule detecting device 100. That is, one cycle of the measurement time in the bio-molecule detecting device 100 is 2T.

Meanwhile, since the absorbance extremely slowly changes over time, in a case in which the value of if cannot be clearly determined, the value of if may be obtained by separating the absorbance component by the free molecules 20 and the absorbance component by the binding molecules 22 using a computer simulation.

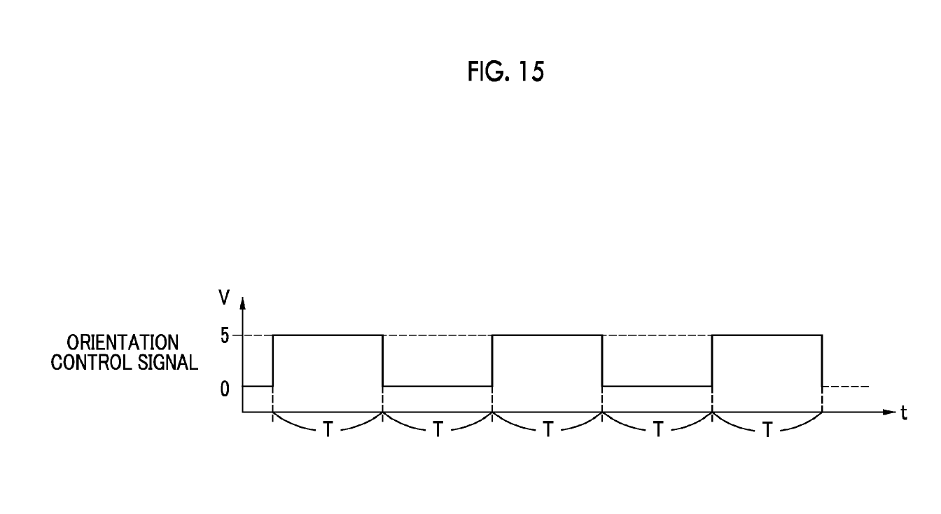

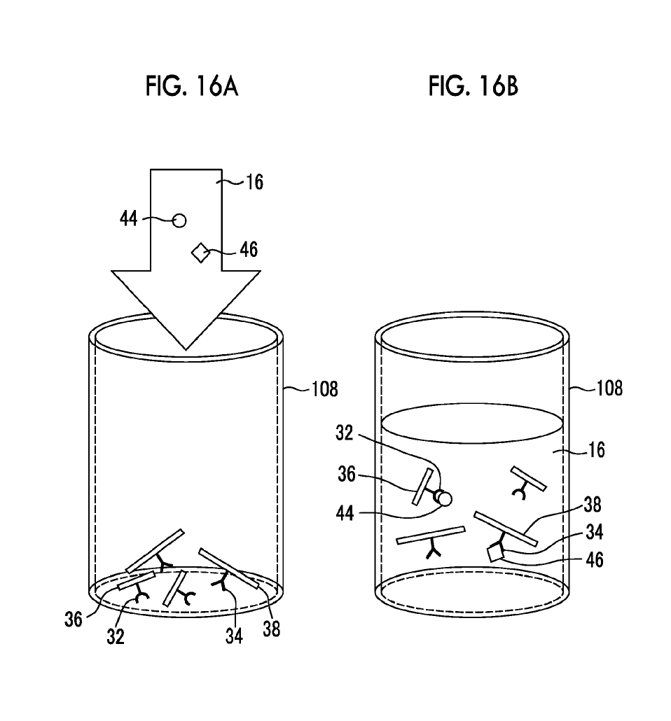

FIG. 15 is a graph illustrating the orientation control signal over a plurality of cycles in the bio-molecule detecting device 100. As illustrated in FIG. 15, the bio-molecule detecting device 100 carries out the above cycle of measurement a plurality of times by switching the orientation control signal at predetermined intervals, and obtains the average values of it, if and iz by arithmetically averaging a plurality of the obtained it, if and iz values respectively. In the embodiment, the above cycle of measurement is carried out ten times, and the average values of it, if and iz are obtained. Thereby, the variation in the measurement results, which is caused by a variety of factors, is averaged.

CPU 132 computes the concentration of the binding molecules 22 from the obtained average values of it, if and iz. Specifically, first, a measured value S is obtained using the following formula (1).

S=(it−if)/(it−iz) (1)

In the formula (1), (it-if) obtains the absorbance increased by the switching of the orientation direction of the binding molecules 22. (it-iz) obtains the absorbance increased by the switching of the orientation direction of the free molecules 20 and the binding molecules 22 by subtracting the maximum value of the obtained absorbance by the absorbance at the measurement. When (it-if) is subtracted by (it-iz), factors that deteriorate the reproductivity of the measurement results of the changes in an optical system and the like are cancelled.

CPU 132 obtains a diagnosis value C (the concentration of the detection subject substance) from the measured value S obtained herein. The diagnosis value C is obtained using the following formula (2).

C=f(S) (2)

Here, f(S) refers to a calibration curve function. When the relationship between the spectrum and the concentration is obtained in advance using standard specimens having a plurality of known concentrations, and the calibration curve function that exhibits the function between the spectrum change and the concentration is obtained based on the above relationship, the concentration of the detection subject substance can be obtained from the change in the spectrum. The bio-molecule detecting device 100 memorizes different calibration curve functions for the respective measurement items, and converts the measured value S into the diagnosis value C. CPU 132 outputs the obtained diagnosis value C to the display unit 102. As such, the light-receiving unit 124, the amplifying unit 126, the A/D converter 128 and CPU 132 operate in harmony with each other so as to form a detection unit that detects bio-molecules by measuring absorbance.

As described above, the bio-molecule detecting device 100 according to Embodiment 1 of the invention is configured so that the orientation direction of the free molecules 20 and the orientation direction of the binding molecules 22 in the solution can be switched by switching the radiation direction of the orientation control light 117. The orientation direction of the free molecules 20 and the orientation direction of the binding molecules 22, which are switched using the orientation control light 117, are directions in which the long-axis direction of the nanorods 8 associated with the free molecules 20 and the long-axis directions of the nanorods 8 associated with the binding molecules 22 become parallel and vertical to the vibration direction of the absorbance measurement light 119. That is, the bio-molecule detecting device 100 switches the absorbance of the free molecules 20 and the binding molecules 22 per molecule by switching the radiation direction of the orientation control light 117. In addition, since there is a difference between the free molecules 20 and the binding molecules 22 in the necessary time to switch the orientation direction following the switching of the radiation direction of the orientation control light 117, the timings for the absorbance of the respective molecules to increase are different. Therefore, the bio-molecule detecting device 100 can compute the extent of contribution of the nanorods associated with the binding molecules in the solution to the absorbance, and can accurately measure the concentration of the detection subject substance with a simple configuration.

In addition, in the above configuration, since the bio-molecule detecting device 100 controls the orientation of the free molecules 20 and the orientation of the binding molecules 22 all in the same direction using an external force generated by the orientation control light 117, a high-sensitivity measurement is possible compared with a case in which a measurement is made using a random movement called the Brownian motion.

Meanwhile, in the embodiment, a case in which an antigen-antibody reaction is used has been described as an example, but the combination between the detection subject substance and the substance that specifically bonds to the detection subject substance is not limited to an antigen and an antibody, and, for example, there are cases in which antibodies are detected using antigens, DNAs that carry out hybridization with specific DNAs are detected using the specific DNAs, DNA-bonded protein are bonded using DNAs, receptors are detected using ligands, lectin is detected using sugar, protease detection is used, a high-order structural change is used, or the like. Even in a case in which the combination between the detection subject substance and the substance that specifically bonds to the detection subject substance is not an antigen and an antibody, when a substance that specifically bonds to the detection subject substance and nanorods are bonded so as to configure the free molecules, and the free molecules and the detection subject substance are bonded so as to configure the binding molecules, the concentration of the detection subject substance can be measured using the bio-molecule detecting device according to the embodiment.

In addition, in the embodiment, in order to facilitate the description of the computation of the concentration of the detection subject substance from the measurement results, the computation of the detection subject substance in a case in which the graph of the measurement result is schematically illustrated has been described, but the computation does not necessarily need to be made in the above manner, and, for example, the concentration of the detection subject substance may be computed by determining a point, at which the absorbance of the free molecules is saturated, based on an inflection point on the graph.

In addition, the time interval at which the orientation control signal is switched between 5 V and 0 V is desirably changed based on the volume of the free molecules or the binding molecules, the viscosity of a solvent, the temperature of a solution, and the like. That is, the time period necessary for the orientation direction of the free molecules to begin to change by the switching of the radiation direction of the orientation control light and then be completely switched is determined by the volume of the free molecules, the viscosity of a solvent, the temperature of a solution, the degree of ease for the free molecules to rotate in the solution, and the like. In addition, the time period necessary for the orientation direction of the binding molecules to be changed is determined by the volume of the binding molecules, the viscosity of a solvent, the temperature of a solution, the degree of ease for the binding molecules to rotate in the solution, and the like. For example, in a case in which the free molecules cannot be easily rotated in the solution, such as a case in which the viscosity of a specimen is high, since the time period necessary for the orientation direction of the free molecules to be completely switched becomes long, it is desirable to extend the period, during which the orientation control signal is set to 5 V or 0 V, long enough for the orientation direction of the free molecules to be completely switched. The above fact shall apply to the switching of the orientation direction of the binding molecules. Here, the time periods necessary for the orientation directions of both the free molecules and the binding molecules to be completely switched can be determined based on the results of absorbance measurement. For example, in FIG. 14, time periods necessary for the orientation directions of both the free molecules and the binding molecules to be completely switched can be obtained by subtracting the time T4, at which the absorbance becomes the maximum value, by the time T1, at which the orientation control signal is first set to 5 V, that is, carrying out T4-T1.

In addition, in the embodiment, a laser having a wavelength of 1000 nm and an output of 700 mW has been used as the orientation control light 117, but the orientation control light 117 is not limited to the above laser. The wavelength and output intensity of the orientation control light 117 are desirably determined based on the volumes, masses and the like of the free molecules and the binding molecules, and the degree of ease for rotating in a solution, which depends on the above parameters. The wavelength of the orientation control light 117 is not limited as long as the free molecules and the binding molecules can be oriented and there is no influence on the absorbance measurement. In addition, the output of the laser is desirably set to an output at which a difference in the necessary time for the switching of the orientation direction appears between the free molecules and the binding molecules.

In addition, in the embodiment, light having a wavelength of 905 nm and an output of 0.1 mW has been used as the absorbance measurement light 119, but the light used as the absorbance measurement light 119 is not limited to the above light. The wavelength of the absorbance measurement light 119 is not limited as long as the absorbance is changed by the change in the orientation direction of the nanorods, but a light having a wavelength, at which the absorbance by the nanorods becomes the maximum, is desirably used. When the absorbance is measured using light having a wavelength at which the absorbance by the nanorods becomes the maximum, since the absorbance is most significantly changed by the change in the orientation direction of the nanorods, it becomes easy to separate and compute the free molecules and the binding molecules. In addition, the output of the absorbance measurement light 119 is not limited as long as the absorbance can be measured. In addition, the light source unit 118 may be configured by combining a lamp and an interference filter.

Meanwhile, in the embodiment, the arithmetic average of the measurement results has been obtained through repetitive measurements, but the arithmetic average does not necessarily need to be carried out, and what is obtained may be determined depending on what the user really wishes to obtain. For example, in a case in which the user wishes to carry out a fast measurement, the result may be displayed after one cycle of measurement. In addition, in a case in which the user wishes to carry out a higher-accuracy measurement, the result with an improved measurement accuracy may be displayed after several cycles of measurement.

Meanwhile, in FIGS. 2A and 2B, the nanorod 8 is illustrated using a column in order to make the description easily understandable, but the shape of the actual nanorod 8 is not limited to a perfectly columnar shape. In addition, the shape of the nanorod 8 is not limited as long as the absorbance is changed by the orientation of the long-axis direction with respect to the vibration direction of the absorbance measurement light.

### Embodiment 2

Embodiment 2 is an aspect in which two kinds of antibodies are used and two kinds of specific antigens, which are detection subject substances, are detected in a homogeneous solution. FIGS. 16A and 16B are schematic views illustrating the overview of an antigen-antibody reaction in a bio-molecule detecting device according to Embodiment 2. Here, antibodies 32 and antibodies 34 are in the reagent cup 108. An antibody 32 is bonded with a nanorod 36 so as to form a free molecule (hereinafter referred to as free molecule A). The antibody 34 is bonded with a nanorod 38 so as to form a free molecule (hereinafter referred to as free molecule B).

When a specimen 16 is fed and stirred in the reagent cup 108, in a case in which antigens 44 that specifically bond to the antibodies 32 are present in the specimen, an antigen-antibody reaction is caused between the free molecule A and the antigen 44, and the antibody 32 and the antigen 44 are specifically bonded. Similarly, in a case in which antigens 46 that specifically bond to the antibodies 34 are present in the specimen, an antigen-antibody reaction is caused between the free molecule B and the antigen 46, and the antibody 34 and the antigen 46 are specifically bonded. Similarly to the case described in Embodiment 1, some of the antibodies 32 and the antibodies 34 remain in the solution without causing an antigen-antibody reaction. Hereinafter, a complex of the free molecule A, which has caused an antigen-antibody reaction, and the antigen 44 will be called a binding molecule A, and a complex of the free molecule B, which has caused an antigen-antibody reaction, and the antigen 46 will be called a binding molecule B. In the present embodiment, PSA is used as the antigen 44, which is the detection subject substance, and squamous cell carcinoma (SCC) antigen is used as the antigen 46. In addition, an anti-PSA antibody that specifically bonds to PSA is used as the antibody 32, and an SCC antibody that specifically bonds to the SCC antigen is used as the antibody 34.

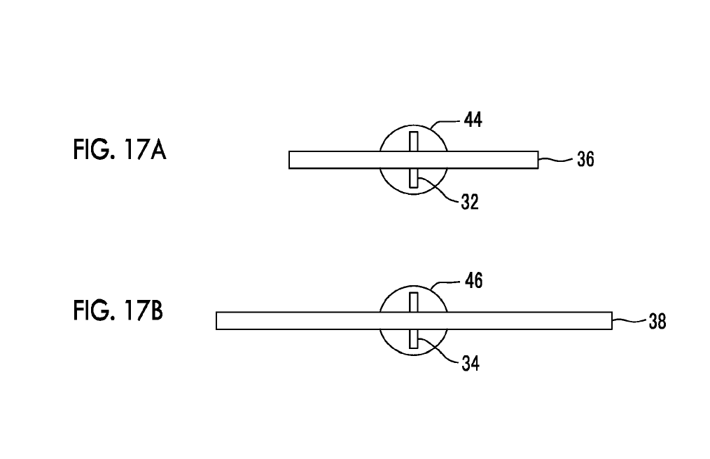

FIGS. 17A and 17B are views of the binding molecule A and the binding molecule B seen from above the nanorod 36 and the nanorod 38. The nanorod 36 and the nanorod 38 have different lengths in the long-axis direction, and the nanorod 38 has a longer length in the long-axis direction. In the embodiment, a gold nanorod having a short axis of 10 nm and a long axis of 50 nm is used as the nanorod 36. In addition, a gold nanorod having a short axis of 10 nm and a long axis of 60 nm is used as the nanorod 38.

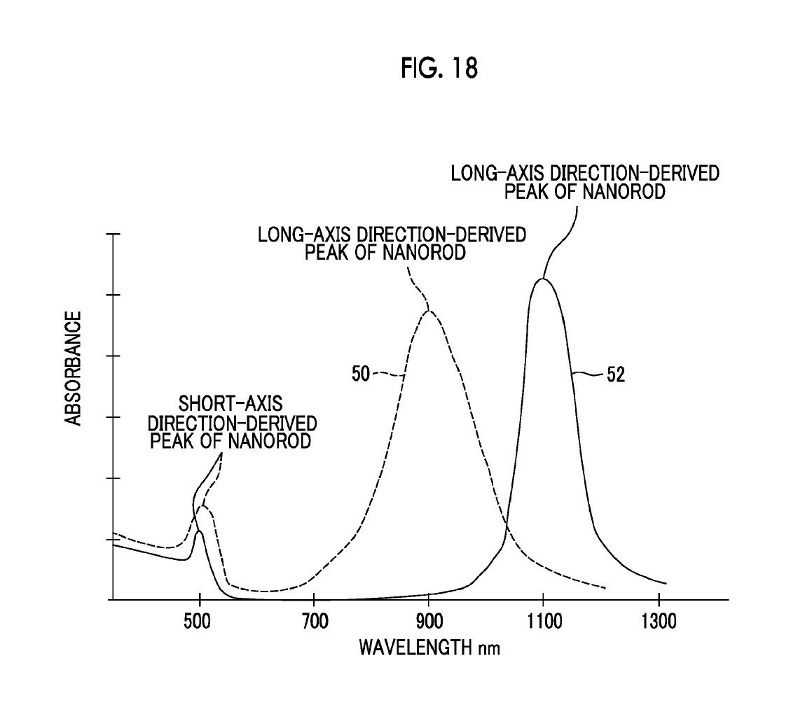

FIG. 18 is a graph drawing the change in the absorbance by the nanorod 36 or the nanorod 38 with respect to the wavelength of light. A graph 50 is a graph indicating the absorbance by the nanorod 36. A graph 52 is a graph indicating the absorbance by the nanorod 38. Generally, in the nanorod, as the length in the long-axis direction increases, a plasmon resonance wavelength derived from the long axis appears on a longer wavelength side. In this example, a peak derived from the long-axis direction of the nanorod 36 appears in the vicinity of a wavelength of 900 nm. In addition, a peak derived from the long-axis direction of the nanorod 38 appears in the vicinity of a wavelength of 1000 nm. Meanwhile, here, the graphs are schematically illustrated in order to facilitate the description.

The bio-molecule detecting device according to Embodiment 2 of the invention radiates absorbance measurement light on a solution in which two kinds of the free molecules and two kinds of the binding molecules are present in a mixed state, and carries out the detection or quantity determination of each of two kinds of the detection subject substances. Hereinafter, the bio-molecule detecting device according to the embodiment will be described in detail.

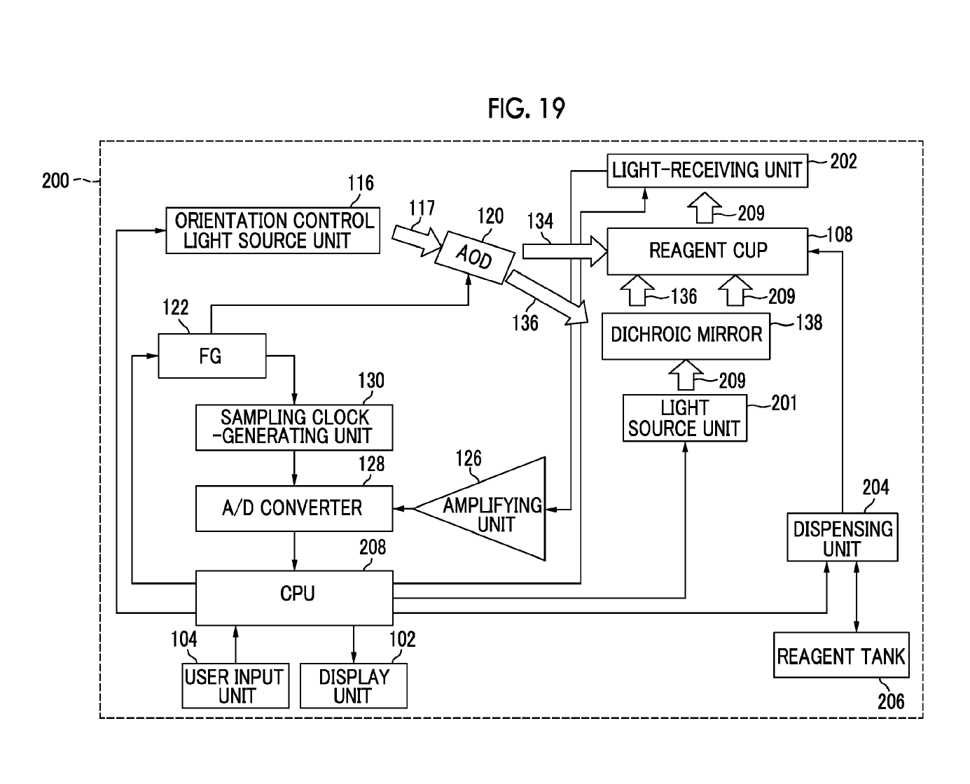

FIG. 19 is a block diagram illustrating the principal configuration of the bio-molecule detecting device 200 according to Embodiment 2 of the invention. Meanwhile, the same configuration element as in the bio-molecule detecting device 100 illustrated in Embodiment 1 will be given the same reference numeral, and will not be described.

Compared with the configuration of the bio-molecule detecting device 100 illustrated in Embodiment 1, in the bio-molecule detecting device 200, a light source unit 201, a light-receiving unit 202, a dispensing unit 204, a reagent tank 206 and CPU 208 are mainly different.

The dispensing unit 204 sucks antibodies designated by the user from the reagent tank 206, in which a plurality of antibodies is stored in respectively separate containers, and dispenses into the reagent cup 108.

The light source unit 201 radiates light linearly polarized by a polarizer included in the unit toward the reagent cup 108. The light source unit 201 is a light source that can select light radiated from light having a wavelength of 905 nm and light having a wavelength of 1.1 μm (1100 nm). The output of the light source unit 201 is 0.1 mW. Two kinds of wavelengths that can be radiated by the light source unit 201 are a wavelength in the vicinity of the wavelength at which the peak derived from the long-axis direction of the nanorod 36 appears and a wavelength in the vicinity of the wavelength at which the peak derived from the long-axis direction of the nanorod 38 appears respectively. Hereinafter, light radiated from the light source unit 201 will be referred to as absorbance measurement light 209.

The light-receiving unit 202 receives the absorbance measurement light 209 which has transmitted through the reagent cup 108. The light-receiving unit 202 is configured to receive an order (S1) from CPU 208 and receive the absorbance measurement light 209 using a filter matched with the wavelength of the absorbance measurement light 209. The detailed configuration of the light-receiving unit 202 will be described below.

CPU 208 carries out the computation of digital data sent from the A/D converter 128, and outputs the result to the display unit 102. In addition, CPU 208 instructs and orders the respective operations of the orientation control light source unit 116, the light source unit 201, the dispensing unit 204, FG 122 and the light-receiving unit 202 based on signals input from the user input unit 104. Specifically, CPU 208 carries out the ordering of the ON and OFF of the orientation control light source unit 116 and the light source unit 201. In addition, CPU carries out the ordering of designating a reagent to use and starting a dispensing operation with respect to the dispensing unit 204. Furthermore, CPU carries out the ordering of instructing and outputting a signal waveform to output with respect to FG 122. In addition, CPU carries out the ordering of switching filters with respect to the light-receiving unit 202.

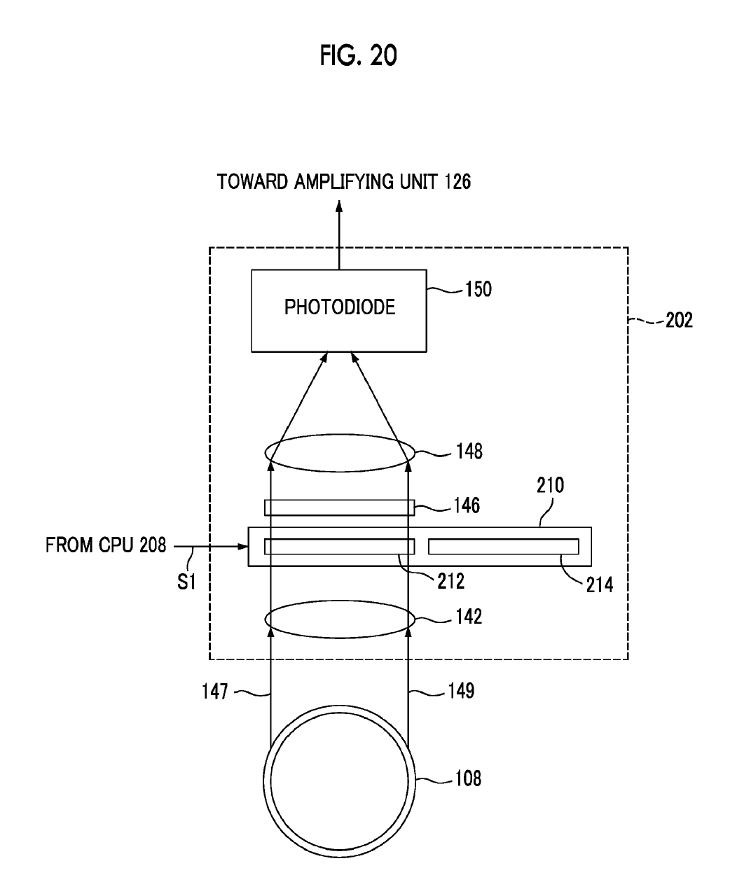

The configuration of the light-receiving unit 202 will be described in detail using FIG. 20. FIG. 20 is a schematic view expressing the detailed configuration of the light-receiving unit 202 in the bio-molecule detecting device 200 according to Embodiment 2.

A filter-switching unit 210 in the light-receiving unit 202 has two kinds of filters which are a filter 212 and a filter 214. The two kinds of filters are mobile, and the filters, through which light collected using the lens 142 passes, can be switched. The filter-switching unit 210 receives the order (S1) from CPU 208, and switches the filters to be used in accordance with the wavelength of the absorbance measurement light 209 radiated from the light source 201. Specifically, a filter to be used is moved to a location, through which light collected using the lens 142 passes, and the other filter not to be used is set aside to a location through which the light does not pass. In the embodiment, a bandpass filter that transmits light having a wavelength of 905 nm is used as the filter 212. A bandpass filter that transmits light having a wavelength of 1.1 um is used as the filter 214. CPU 208 outputs an order of using the filter 212 to the light-receiving unit 202 in a case in which light having a wavelength of 905 nm is radiated on the light source unit 201. In addition, CPU 208 outputs an order of using the filter 214 to the light-receiving unit 202 in a case in which light having a wavelength of 1.1 pm is radiated on the light source unit 201. The above configuration can prevent the entrance of light having a wavelength, which is not used for the absorbance measurement light 209, into the light-receiving unit 202, and can decrease noises.

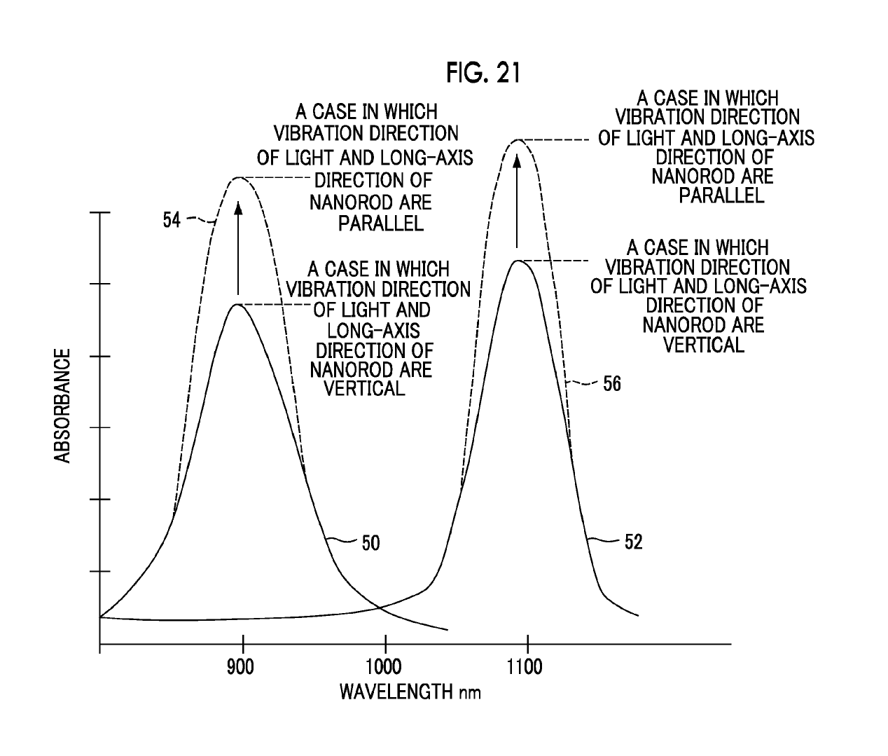

Even in the embodiment, the switching of the radiation direction of the orientation control light 117 by AOD 120 switches the absorbance derived from the long-axis directions of the nanorod 36 and the nanorod 38 between the maximum and the minimum. FIG. 21 is a graph illustrating a change in absorbance caused by the switching of the orientation direction of the nanorod 36 and the nanorod 38. In FIG. 21, a curve 50 is a graph indicating the absorbance by the nanorod 36 with respect to the change of the wavelength. A curve 52 is a graph indicating the absorbance by the nanorod 38 with respect to the change of the wavelength. Meanwhile, the graphs in FIG. 21 are schematically illustrated in order to facilitate the description.

The absorbance of the nanorod 36 used in the embodiment with respect to light in the vicinity of a wavelength of 900 nm increases as the orientation of the long-axis direction of the nanorod 36 approximates in the parallel direction with respect to the vibration direction of the absorbance measurement light 209. In FIG. 21, a change in the absorbance caused by the switching of the orientation direction of the nanorod 36 is illustrated using a curve 54 illustrated by a broken line. In addition, the absorbance of the nanorod 38 with respect to light in the vicinity of a wavelength of 1.1 μm increases as the orientation of the long-axis direction of the nanorod 38 approximates in the parallel direction with respect to the vibration direction of the absorbance measurement light 209. In FIG. 21, a change in the absorbance caused by the switching of the orientation direction of the nanorod 38 is illustrated using a curve 56 illustrated by a broken line.

Both in the nanorod 36 and in the nanorod 38, the absorbance becomes the minimum in a case in which the vibration direction of the absorbance measurement light 209 and the long-axis direction of the nanorod are vertical, and the absorbance becomes the maximum in a case in which the vibration direction of the absorbance measurement light 209 and the long-axis direction of the nanorod are parallel. However, the wavelength at which the peak of the absorbance derived from the long-axis direction of the nanorod 36 appears and the wavelength at which the peak of the absorbance derived from the long-axis direction of the nanorod 38 appears are sufficiently away from each other. In addition, in the absorbance spectra of the nanorod 36 and the nanorod 38, except for the absorbance in the vicinity of the peak, there is an extremely small amount of change caused by the change in the orientation. Therefore, in a case in which the free molecules and the binding molecules, which include the nanorods 36, are measured, when light in the vicinity of a wavelength of 900 nm is used as the absorbance measurement light 209, the absorbance can be measured without considering the influence of the nanorods 38. Similarly, in a case in which the free molecules and the binding molecules, which include the nanorods 38, are measured, light in the vicinity of a wavelength of 1.1 μm is used as the absorbance measurement light 209. As such, even when a plurality of kinds of the free molecules and the binding molecules is present in a mixed state, since the wavelengths, at which the peaks derived from the long-axis direction of the nanorod appear, are different, the respective absorbances of desired free molecules and desired binding molecules can be measured.

Similarly to Embodiment 1, the bio-molecule detecting device 200 according to the embodiment carries out a measurement using the difference between the necessary time for the orientation of the free molecules to be completed by the radiation of the orientation control light and the necessary time for the orientation of the binding molecules to be completed by the radiation of the orientation control light. That is, when the orientation control light is radiated, a difference is caused between the timing at which the absorbance of absorbance nanorods by the nanorods associated with the free molecules changes and the timing at which the absorbance of the nanorods associated with the binding molecules changes. In addition, the extent of contribution to the absorbance of the nanorods associated with the binding molecules is computed from the change of the absorbance of the solution over time, and the quantity of the detection subject substance is determined. In the absorbance measurement, light having a wavelength band, in which the absorbance derived from the long-axis direction of the nanorods associated with both the free molecules and the binding molecules in a measurement subject appears, is used.

Subsequently, the measurement action of the bio-molecule detecting device 200 will be described. The measurement action of the bio-molecule detecting device 200 is basically the same as the measurement action of the bio-molecule detecting device 100 described in Embodiment 1, but is different in minutiae. Since the principle of separating and detecting the binding molecules from the solution, in which the free molecules and the binding molecules are present in a mixed state, has been described in Embodiment 1, here, a principle of detecting only the target binding molecules from two kinds of binding molecules present in the solution in a mixed state will be described.

First, the bio-molecule detecting device 200 determines which one of the two kinds of binding molecules is first detected. For example, the user who uses the bio-molecule detecting device 200 can make an arbitrary determination using the user input unit 104.

Here, a case in which the binding molecules A having the nanorods 36 are first measured will be described. CPU 208 outputs an order of instructing the use of the filter 212 to the filter-switching unit 210 in the light-receiving unit 202. The filter-switching unit 210 receives the order from the CPU 208, and moves the filter 212 to a location at which light collected using the lens 142 passes. In addition, CPU 208 outputs an order of radiating the absorbance measurement light 209 having a wavelength of 905 nm to the light source unit 201.

When the absorbance measurement light 209 is radiated on the reagent cup 108, the nanorods 36 in the solution cause localized surface plasmon resonance with the absorbance measurement light 209, and absorbs the absorbance measurement light 209. In addition, the nanorods 38 also receive the absorbance measurement light 209 in a similar manner, but the fraction thereof is as small as ignorable compared with the nanorods 36.

The absorbance measurement light 209 transmits through the solution while being weakened due to the absorption into the nanorods 36, and enters the light-receiving unit 202. The absorbance measurement light 209 is collected using the lens 142, and enters the filter 212. Since the filter 212 transmits light having a wavelength of 905 nm, the absorbance measurement light 209 transmits through the filter 212, and reaches the photodiode 150. The absorbance iz1 of the absorbance measurement light 209 by the nanorods 36 in a case in which the orientation control signal is 0 V is measured from the output of the original absorbance measurement light 209 radiated from the light source unit 201 and the output of the absorbance measurement light 209 received using the photodiode 150.

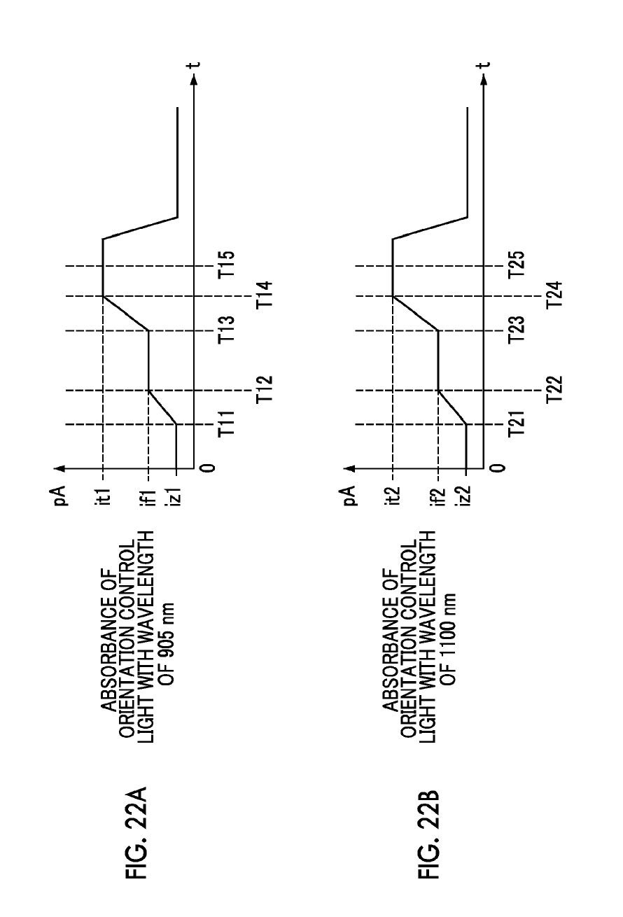

The measurement results of the absorbance of the solution in the reagent cup 108 using the bio-molecule detecting device 200 will be illustrated in FIGS. 22A and 22B. Meanwhile, the graphs are schematically illustrated in order to facilitate the description.

FIG. 22A illustrates the change of the absorbance of light having a wavelength of 905 nm over time by the solution in the reagent cup 108. This absorbance is the absorbance mainly by the nanorods 36. As the measurement begins at T11, the orientations of both the free molecules A and the binding molecules A change so that the absorbance increases. The switching of the orientation direction is completed faster in the free molecules A than in the binding molecules A, and, when the switching of the orientation direction of all the free molecules A is completed at a time T12, the absorbance of light having a wavelength of 905 nm is saturated at a value of if1. After that, the graph of the absorbance increases again at a time T13. When the switching of the orientation direction of the binding molecules A is completed at a time T14, the absorbance of light having a wavelength of 905 nm is saturated at a value of it1. When the orientation control signal becomes 0 V at T15, the absorbance of light having a wavelength of 905 nm becomes iz1 at a time slightly slower than the time T15.

The bio-molecule detecting device 200 carries out one cycle of measurement a plurality of times by switching the orientation control signal at predetermined intervals, and obtains an average value of the iz1, if1 and it1 values by arithmetically averaging a plurality of the obtained iz1, if1 and it1 values respectively.

Subsequently, CPU 208 computes the concentration of the binding molecules A from the obtained average values of iz1, if1 and it1. Specifically, the same computation as in a case in which the measured value S is obtained in Embodiment 1 is carried out so as to obtain the measured value S1. In addition, the measured value S1 is converted into the concentration C1 using the calibration curve function f1(S). CPU 208 outputs the obtained concentration C1 to the display unit 102.

Next, the bio-molecule detecting device 200 carries out the measurement of the binding molecules B. CPU 208 outputs an order of instructing the use of the filter 214 to the filter-switching unit 210 in the light-receiving unit 202. The filter-switching unit 210 receives the order from CPU 208, and moves the filter 214 to a location at which light collected using the lens 142 passes. In addition, CPU 208 outputs an order of radiating the absorbance measurement light 209 having a wavelength of 1.1 μm to the light source unit 201.

FIG. 22B illustrates the change of the absorbance of light having a wavelength of 1.1 μm over time by the solution in the reagent cup 108. This absorbance is the absorbance mainly by the nanorods 38.

The absorbance of the absorbance measurement light 209 by the nanorods 38 in a case in which the orientation control signal is 0 V is indicated by iz2. As the measurement begins at T21, the orientations of both the free molecules B and the binding molecules B change so that the absorbance increases. Since the switching of the orientation direction is completed faster in the free molecules B than in the binding molecules B, when the switching of the orientation direction of all the free molecules B is completed at a time T22, the absorbance of light having a wavelength of 1.1 μm is saturated at a value of if2. After that, the graph of the absorbance increases again at a time T23. When the switching of the orientation direction of the binding molecules A is completed at a time T24, the absorbance of light having a wavelength of 1.1 μm is saturated at a value of it2. When the orientation control signal becomes 0 V at T25, the absorbance of light having a wavelength of 1.1 μm becomes iz2 at a time slightly slower than the time T25.

The bio-molecule detecting device 200 carries out one cycle of measurement a plurality of times by switching the orientation control signal at predetermined intervals, and obtains an average value of the iz2, if2 and it2 values by arithmetically averaging a plurality of the obtained iz2, if2 and it2 values respectively.

The switching timing of the orientation control signal in a case in which the binding molecules B are measured is different from a case in which the binding molecules A are measured. This is because the volumes and masses of the binding molecules A, the free molecules A, the binding molecules B and the free molecules B are different respectively, and the necessary times for the respective molecules to be completely oriented are different.

As illustrated in FIGS. 22A and 22B, the timings at which the absorbance increases or is saturated are different between a case in which the binding molecules A are measured and a case in which the binding molecules B are measured. This results from the degrees of ease of motion of the binding molecules A and the binding molecules B in the solution due to the difference in volume.

Subsequently, CPU 208 computes the concentration of the binding molecules B from the obtained average values of iz2, if2 and it2. Specifically, the same computation as in a case in which the measured value S is obtained in Embodiment 1 is carried out so as to obtain the measured value S2. In addition, the measured value S2 is converted into the concentration C2 using the calibration curve function f2(S). CPU 208 outputs the obtained concentration C2 to the display unit 102.

As described above, according to the bio-molecule detecting device 200 according to Embodiment 2 of the invention, in addition to the configuration of the bio-molecule detecting device 100 described in Embodiment 1, two kinds of nanorods have been used, and the filter-switching unit 210 has been configured to be capable of switching two kinds of filters. The two kinds of nanorods have different wavelengths at which the change appears in the absorbance derived from the long-axis direction caused by the switching of the orientation direction. Therefore, when light having a wavelength corresponding to the nanorods associated with the binding molecules including the detection subject substance is used as the absorbance measurement light, only the absorbance of the binding molecules including the detection subject substance can be measured. That is, the concentration of the detection subject substance can be accurately measured from the specimen in which a plurality of components is present in a mixed state. As such, the detection of a plurality of detection subject substances from a specimen is important in order to improve the accuracy of immunodiagnosis.

Meanwhile, in the embodiment, the gold nanorod having a short axis of 10 nm and a long axis of 50 nm and the gold nanorod having a short axis of 10 nm and a long axis of 60 nm have been used as the two kinds of nanorods, but the nanorods used in measurement is not limited to a nanorod having the above length or the above aspect ratio. As the two kinds of nanorods, two nanorods, for which there is a difference in the plasmon resonance wavelength derived from the long-axis direction so that only the absorbance of one nanorod can be measured, may be used.

In addition, in the embodiment, a laser having a wavelength of 1000 nm and an output of 700 mW has been used as the orientation control light 117, but the orientation control light 117 is not limited to the above laser. The output of the orientation control light 117 is desirably determined based on the degree of ease for rotating in a solution, which depends on the volume and mass of the free molecule, the volume and mass of the binding molecule, and the like. The wavelength of the orientation control light 117 is not limited as long as the free molecules and the binding molecules can be oriented and there is no influence on the absorbance measurement.

In addition, in the embodiment, light having a wavelength of 905 nm and an output of 0.1 mW and light having a wavelength of 1.1 pm and an output of 0.1 mW have been used as the absorbance measurement light 209, but the light used as the absorbance measurement light 209 is not limited to the above light. The wavelength of the absorbance measurement light 209 is not limited as long as the absorbance is changed by the change in the orientation direction of the nanorods, but light having a wavelength, at which the absorbance by the nanorods becomes the maximum, is desirably used. When the absorbance is measured using light having a wavelength at which the absorbance by the nanorods becomes the maximum, since the absorbance is changed most significantly by the change of the orientation direction of the nanorods, it becomes easy to separate and compute the free molecules and the binding molecules. In addition, the output of the absorbance measurement light 209 is not limited as long as the absorbance of the output can be measured. In addition, the light source unit 201 may be configured by combining a lamp and an interference filter.

Meanwhile, in the embodiment, a case in which an antigen-antibody reaction is used has been described as an example, the combination between the detection subject substance and the substance that specifically bonds to the detection subject substance is not limited to an antigen and an antibody, and, for example, there are cases in which antibodies are detected using antigens, specific DNAs and DNAs that carry out hybridization with the DNAs, DNAs and DNA-bonded protein, ligands and receptors, sugar and lectin, protease detection, a high-order structural change, or the like may be used. Even in a case in which the combination between the detection subject substance and the substance that specifically bonds to the detection subject substance is not between an antigen and an antibody, when a substance that specifically bonds to the detection subject substance and the nanorods are bonded so as to configure the free molecules, and the free molecules and the detection subject substance are bonded so as to configure the binding molecules, the concentration of the detection subject substance can be measured using the bio-molecule detecting device according to the embodiment.

In addition, in the embodiment, a case in which there are two kinds of detection subject substances has been described, but the number of the kinds of the detection subject substances may be three or more. Even in this case, when the substance that specifically bonds to the respective detection subject substances is bonded with nanorods having respectively different aspect ratios, and the same measurement is carried out, the concentrations of the respective detection subject substances can be measured.

In addition, in Embodiment 1 or Embodiment 2, the polarization axis may be rotationally moved using linearly-polarized light as the orientation control light, thereby orientating the free molecules and the binding molecules. The free molecules, on which the linearly-polarized light has been radiated, and the binding molecules, on which the linearly-polarized light has been radiated, are oriented in a specific direction determined by the polarization axis of light. In a case in which the linearly-polarized light is used as the orientation control light, a half-wavelength plate can be used instead of AOD. The half-wavelength plate is a phase plate having a function of changing the optical path difference of light vibrating in the vertical direction by half wavelength, and is used to rotationally move the polarization axis of light. Light linearly polarized in a parallel direction to the optical axis direction of the half-wavelength plate passes through the half-wavelength plate, however, for light linearly polarized in a direction forming 45 degrees with the optical axis direction of the half-wavelength plate, the polarization axis rotationally moves by 90 degrees. That is, a case in which light is passed and a case in which the polarization axis of light is changed by 90 degrees can be switched by switching the angle of the half-wavelength plate with respect to linearly-polarized light. That is, the free molecules and the binding molecules can be oriented in two directions by rotationally moving the polarization axis of light linearly polarized using the half-wavelength plate.

Meanwhile, in Embodiment 1 and Embodiment 2, a case in which the linearly-polarized absorbance measurement light is radiated on the solution, that is, a case in which the polarization plane radiates sole absorbance measurement light on the solution has been described as an example, but the absorbance measurement light does not necessarily need to be linearly-polarized light having a sole polarization plane. In order to exhibit the effects of Embodiment 1 and Embodiment 2, the absorbance measurement light simply needs to have at least one linearly-polarized light component in a specific direction. Here, the light having a linearly-polarized light component in the specific direction refers to light in which the orientation relationship between the nanorods and the linearly-polarized light component in the specific direction is changed by the change in the orientation direction of the nanorods so that the absorbance by the nanorods is changed with respect to the linearly-polarized light component in the specific direction. For example, the bio-molecule detecting device may be configured to radiate randomly-polarized absorbance measurement light and to be provided with an analyzer ahead of the light-receiving unit so as to receive only the linearly-polarized light component in the specific direction. Here, the randomly-polarized light refers to light in which the vibration direction of the light is random, and components vibrating in a variety of directions are present.

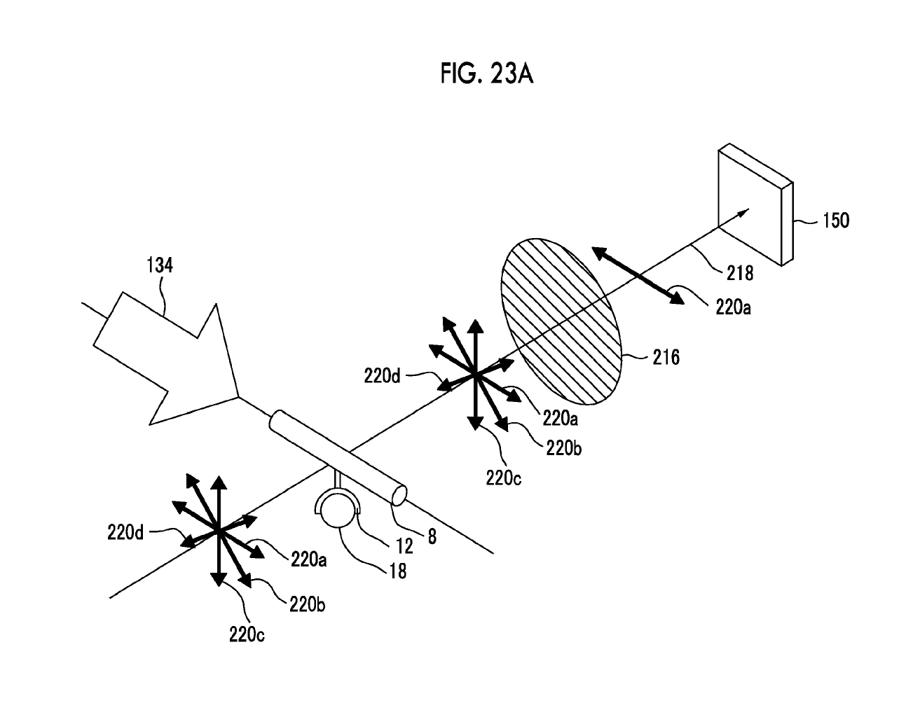

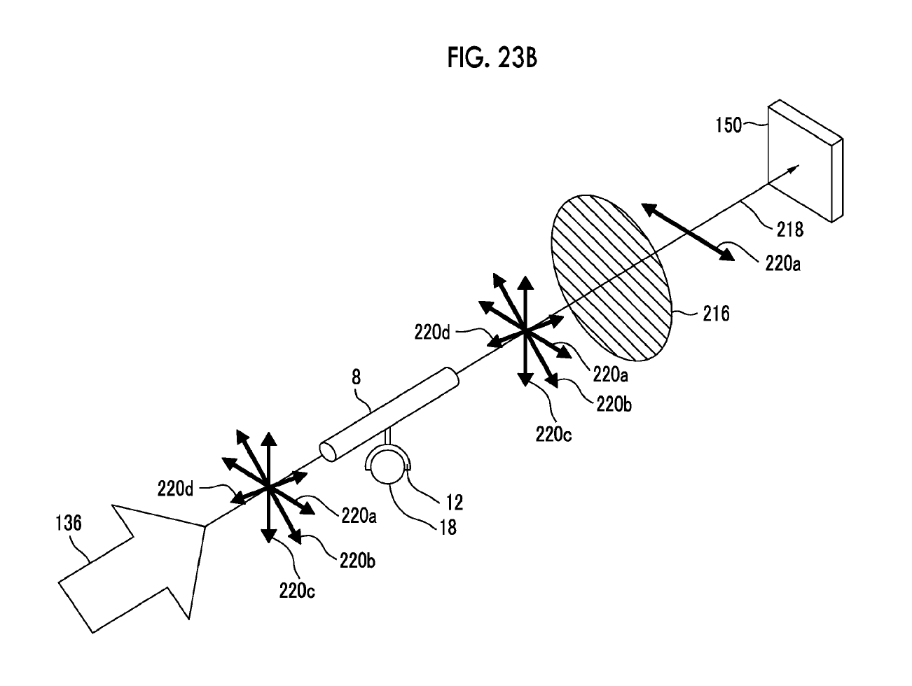

FIGS. 23A and 23B are conceptual views expressing the orientation direction of the nanorod 8 and the vibration direction of the randomly-polarized absorbance measurement light 218 when the orientation control light 134 and 136 is radiated respectively. The radiation direction of the orientation control light 134 is different by 90 degrees from that of the orientation control light 136. The vibration directions 220a to 220d of the absorbance measurement light 218 indicate the vibration directions of light in a plane vertical to the traveling direction of the absorbance measurement light 218. In FIGS. 23A and 23B, the fact that there are a variety of vibration directions of the absorbance measurement light 218 is indicated using the vibration directions 220a to 220d; however, in actual cases, not only the illustrated components but also more components in all angular directions are included.

An analyzer 216 transmits components vibrating in the specific direction of the absorbance measurement light 218, which has transmitted through the nanorods 8, and blocks components vibrating in directions other than the specific direction. In other words, light which has transmitted through the analyzer 216 becomes light vibrating only in the specific direction. The component vibrating in the specific direction transmitted by the analyzer 216 refers to a component vibrating in the same direction as the long-axis direction of the nanorods 8 oriented by the orientation control light 134. The vibration direction of the absorbance measurement light 218, which has transmitted through the analyzer 216, becomes the vibration direction 220a in FIGS. 23A and 23B. Thereby, as illustrated in FIG. 23A, of the absorbance measurement light 218 which has transmitted through the nanorods 8, only the components vibrating in the same direction as the long-axis direction of the nanorods 8 oriented by the orientation control light 134 can be allowed to reach the photodiode 150. Meanwhile, as illustrated in FIG. 23B, in the long-axis direction of the nanorods 8 oriented by the orientation control light 136 having a 90-degree angular difference from the orientation control light 134 in the radiation direction, only the components vibrating in a vertical direction reach the photodiode 150. The above configuration enables the measurement of the absorbance of the solution with respect to light vibrating in the specific direction, similarly to a case in which the linearly-polarized absorbance measurement light is radiated, even when randomly-polarized light is used as the absorbance measurement light 218. Meanwhile, the component vibrating in the specific direction transmitted by the analyzer 216 is not necessarily limited to components vibrating in the directions illustrated herein, and may be any component as long as a difference in the absorbance by the nanorods 8 is caused by a change in the orientation direction of the nanorods 8.

In addition, in FIGS. 23A and 23B, an example in which the amplitude is constant regardless of the vibration direction of the absorbance measurement light has been described, but the vibration does not necessarily need to be constant in all directions. Since the photodiode 150 only receives the components vibrating in the specific direction, components vibrating in other directions are blocked.

In a case in which the orientation control signal is 0 V, which is illustrated in FIG. 23B, the long-axis direction of the nanorods 8 oriented by the orientation control light 136 and the vibration direction of light that can transmit through the analyzer 216 become vertical to each other. In this case, of components vibrating in the respective directions of the absorbance measurement light 218, the component vibrating in a direction, in which the light can transmit through the analyzer 216, is not easily absorbed by the nanorods 8.

Meanwhile, in a case in which the orientation control signal is 5 V, which is illustrated in FIG. 23A, the long-axis direction of the nanorods 8 oriented by the orientation control light 134 and the vibration direction of light that can transmit through the analyzer 216 become parallel to each other. In this case, of components vibrating in the respective directions of the absorbance measurement light 218, the component vibrating in a direction, in which the light can transmit through the analyzer 216, is easily absorbed by the nanorods 8.

Even in a case in which the bio-molecule detecting device has the above configuration, when the orientation control signal is changed from 0 V to 5 V, the orientation direction of the nanorods 8 changes, and the long-axis direction of the nanorods 8 and the vibration direction of light that can transmit through the analyzer 216 gradually approximate in parallel. Accordingly, the absorbance of the nanorods 8 with respect to light vibrating in a direction, in which light can transmit through the analyzer 216, increases, and the absorbance of the solution increases. In this case, since the necessary time periods for the orientation to be completed are different between the free molecules and the binding molecules, the timings at which the absorbance increases so as to be saturated are also different. Therefore, even in a case in which the bio-molecule detecting device has the above configuration, when the orientation control signal is changed from 0 V to 5 V, the graph of the change in the absorbance of the solution with respect to time becomes the same shape as in FIG. 14. That is, even in this case, the concentration of the detection subject substance can be measured by carrying out the same computation as in Embodiment 1 on the graph of the absorbance of the solution.

### Embodiment 3

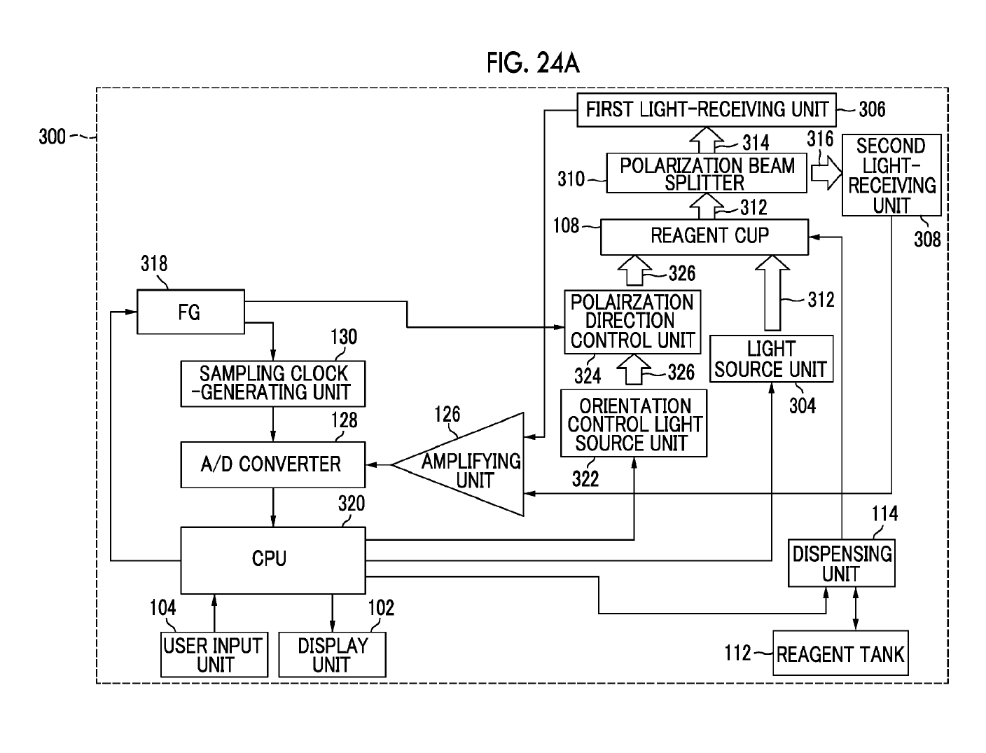

FIG. 24A is a function block diagram for explaining the principal configuration of a bio-molecule detecting device 300. FIG. 24B is a view expressing the positional relationship among a light source unit 304, an orientation control light source unit 322 and a first light-receiving unit 306. FIG. 24B illustrates configuration elements to be used in description by extracting from FIG. 24A, and does not illustrate other configuration elements. Meanwhile, in FIGS. 24A and 24B, the same configuration element as in the bio-molecule detecting device 100 illustrated in Embodiment 1 will be given the same reference numeral, and will not be described.

The light source unit 304 radiates absorbance measurement light 312 only having components vibrated in two orthogonal directions by a polarizer included in the unit toward a first light-receiving unit 306 provided above the reagent cup 108 from the bottom surface of the reagent cup 108 as illustrated in FIG. 24B. Light having a wavelength of 905 nm and an output of 0.1 mW is used as the absorbance measurement light 312.

A polarized beam splitter 310 is provided between the reagent cup 108 and the first light-receiving unit 306. The polarized beam splitter 310 transmits one linearly-polarized light component 314 of the absorbance measurement light 312 linearly polarized in two orthogonal directions, which has transmitted through the reagent cup 108, and reflects the other linearly-polarized light component 316 in a direction that is 90-degree different from that of the linearly-polarized light component 314.

As illustrated in FIG. 24B, the first light-receiving unit 306 is provided above the reagent cup 108 and opposite to the light source unit 304 with the reagent cup 108 interposed therebetween. The first light-receiving unit 306 has a photodiode therein. The first light-receiving unit 306 receives the linearly-polarized light component 314, which has transmitted through the reagent cup 108 and the polarized beam splitter 310, at the photodiode, converts into an analog electric signal, and outputs to the amplifying unit 126. In addition, a bandpass filter is provided in the first light-receiving unit 306. The bandpass filter allows only light having the same wavelength as the absorbance measurement light 312 to reach the photodiode. Thereby, the arrival of light having a different wavelength from the absorbance measurement light 312 at the photodiode and the generation of noises thereby are prevented.

A second light-receiving unit 308 is provided in an optical path of the linearly-polarized light component 316 which is reflected by the polarized beam splitter 310. The second light-receiving unit 308 receives the linearly-polarized light component 316, which has been reflected by the polarized beam splitter 310, at the photodiode provided therein, converts into an analog electric signal, and outputs to the amplifying unit 126. In addition, a bandpass filter is provided in the second light-receiving unit 308. The bandpass filter allows only light having the same wavelength as the absorbance measurement light 312 to reach the photodiode.

FG 318 is a device that can generate voltage signals having a variety of frequencies and waveforms, receives an order output from CPU 320, and outputs respectively different voltage signals to a polarization direction control unit 324 and the sampling clock-generating unit 130. Hereinafter, the signal output to the polarization direction control unit 324 from FG 318 will be referred to as polarization direction control signal.

The orientation control light source unit 322 is provided below the reagent cup 108 as illustrated in FIG. 24B, radiates the orientation control light 326 linearly polarized by the polarizer included in the unit upward from the bottom surface of the reagent cup 108 through the polarization direction control unit 324, and applies an external force to the free molecules and the binding molecules present in the solution in the reagent cup 108, thereby controlling the orientation thereof. A laser having a wavelength of 1.3 μm and an output of 700 mW is used as the orientation control light 326. The orientation control light 326 is wide enough to radiate the entire solution of the reagent cup 108.

The polarization direction control unit 324 switches the orientation directions of the free molecules and the binding molecules by switching the polarization direction (vibration direction) of the orientation control light 326. The polarization direction control unit 324 has a half-wavelength plate. The half-wavelength plate is a phase plate having a function of changing the optical path difference of polarized light vibrating in the vertical direction by half wavelength, and is used to rotate the polarization surface of light. Light linearly polarized in a parallel direction to the optical axis direction of the half-wavelength plate passes through the half-wavelength plate, however, for light linearly polarized in a direction forming 45 degrees with the optical axis direction of the half-wavelength plate, the vibration direction changes by 90 degrees. That is, a case in which light is passed and a case in which the vibration direction of light is changed by 90 degrees can be switched by switching the angle of the half-wavelength plate with respect to linearly-polarized light. The half-wavelength plate is held in an electronic half-wavelength plate-rotating element. The polarization direction control unit 324 receives a polarization direction control signal output from FG 318, and rotationally moves the half-wavelength plate-rotating element using an exclusive controller, thereby rotationally moving the half-wavelength plate and switching the vibration direction of the orientation control light 326 by 90 degrees. In other words, the vibration direction of the orientation control light 326 is determined by the voltage signal generated by FG 318.

CPU 320 comprehensively controls the respective operations of the bio-molecule detecting device 300, and carries out the computation and the like of measurement results. CPU 320 controls a timing, at which the polarization direction control unit 324 switches the vibration direction of the orientation control light 326, by designating the polarization direction control signal output by FG 318.

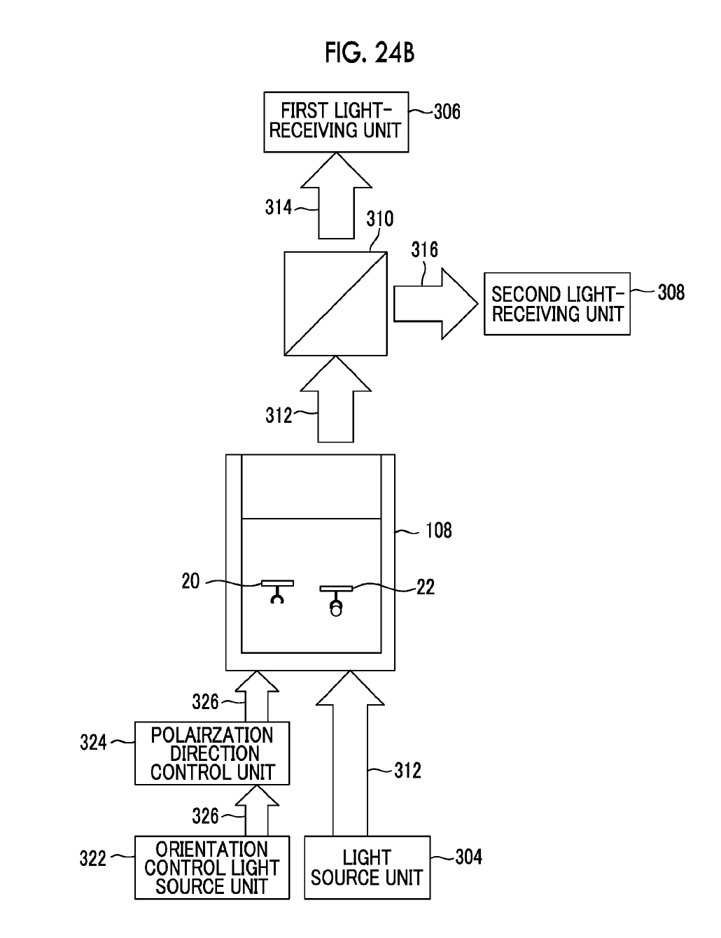

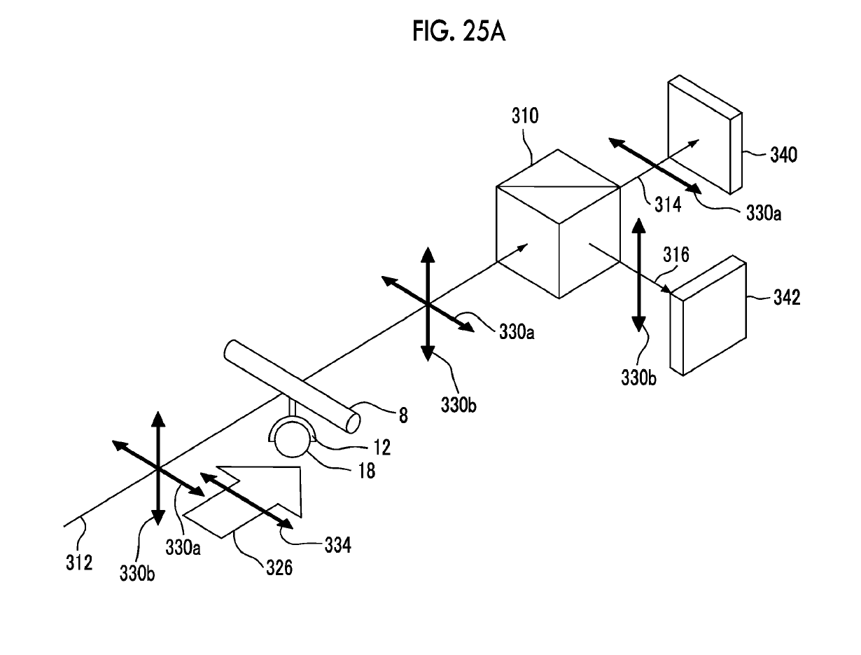

The relationship between the orientation direction of the nanorods with respect to the vibration direction of the orientation control light 326 and the vibration direction of the absorbance measurement light 312 will be described using the conceptual views illustrated in FIGS. 25A and 25B. Meanwhile, FIGS. 25A and 25B do not illustrate unnecessary elements for the description. The absorbance measurement light 312 has components vibrating in vibration directions 330a and 330b in a vertical plane to the traveling direction. In addition, the vibration direction 330a and the vibration direction 330b are orthogonal to each other. That is, the absorbance measurement light 312 is light having two linearly-polarized light components that are orthogonal to each other.

FIG. 25A is a conceptual view in a case in which the polarization direction control signal is 0 V. In a case in which the polarization direction control signal is 0 V, the orientation control light 326 vibrating in the vibration direction 334 is radiated on the reagent cup 108. The vibration direction 334 of the orientation control light 326 in a case in which the polarization direction control signal is 0 V and the vibration direction 330a of the absorbance measurement light 312 are parallel to each other. The nanorods 8 irradiated with the orientation control light 326 vibrating in the vibration direction 334 are oriented toward the long-axis direction in the same direction as the vibration direction 334.

The polarized beam splitter 310 transmits the linearly-polarized light component 314 vibrating in the vibration direction 330a of the absorbance measurement light 312, and reflects the linearly-polarized light component 316 vibrating in the vibration direction 330b The linearly-polarized light component 314, which has transmitted through the polarized beam splitter 310, reaches a photodiode 340 provided in the first light-receiving unit 306. The linearly-polarized light component 316 reflected at the polarized beam splitter 310 reaches a photodiode 342 provided in the second light-receiving unit 308.

FIG. 25B is a conceptual view in a case in which the polarization direction control signal is 5 V. In a case in which the polarization direction control signal is 5 V, the orientation control light 326 vibrating in the vibration direction 340 is radiated on the reagent cup 108. The vibration direction 340 of the orientation control light 326 in a case in which the polarization direction control signal is 5 V and the vibration direction 330b of the absorbance measurement light 312 are parallel to each other. The nanorods 8 irradiated with the orientation control light 326 vibrating in the vibration direction 340 are oriented toward the long-axis direction in the same direction as the vibration direction 340.

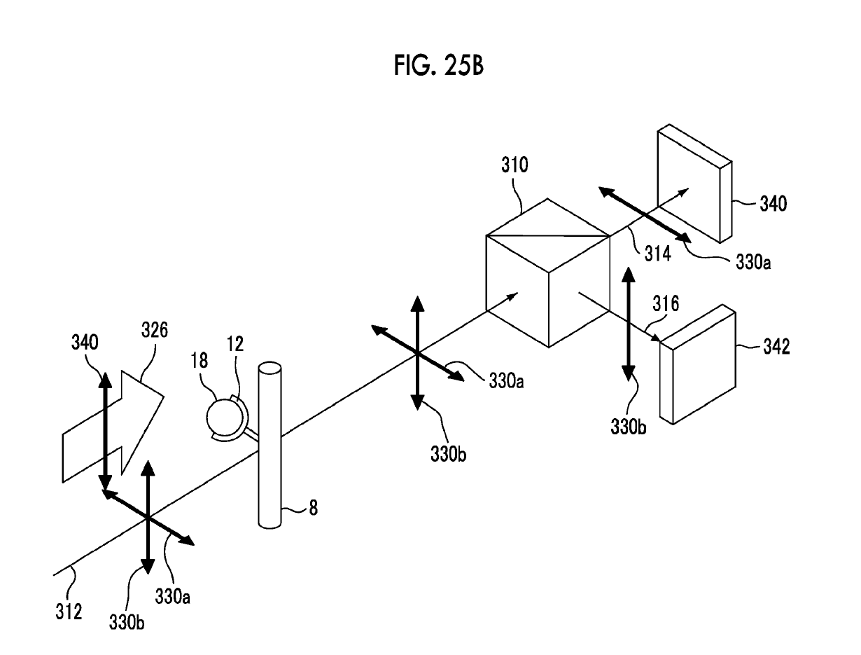

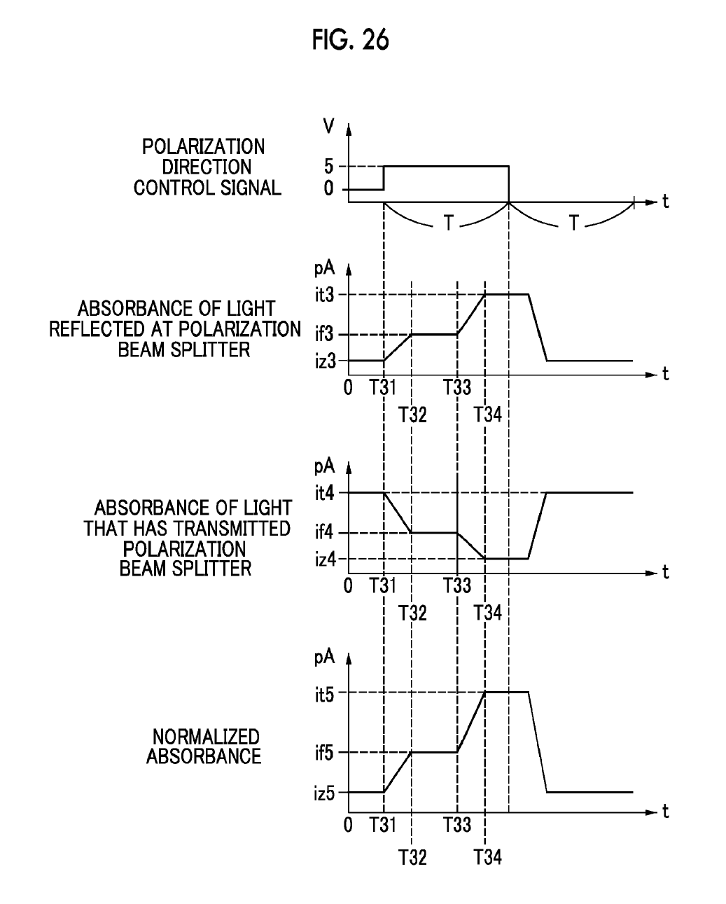

FIG. 26 includes graphs, in which the vertical axis indicates the voltage or absorbance of the polarization direction control signal in the bio-molecule detecting device 300, and the horizontal axis indicates the time t. Meanwhile, here, in order to facilitate the description, the graphs of the absorbance of the orientation control light which has transmitted through the polarized beam splitter, the absorbance of the orientation control light reflected at the polarized beam splitter and the normalized absorbance are schematically illustrated.

Even in the embodiment, similarly to Embodiment 1, the polarization direction control signal output from FG 318 becomes 0 V before the measurement. Before the measurement, the orientation control light 326 is radiated on the solution in the reagent cup 108 so as to orient the free molecules and the binding molecules in the same direction. As the measurement begins, CPU 320 outputs an order of the beginning of the radiation of the absorbance measurement light 312 to the light source unit 304.

When attention is paid to the linearly-polarized light component 316 reflected at the polarized beam splitter 310, the relationship between the linearly-polarized direction and the long-axis direction of the nanorods 8 becomes the same as in Embodiment 1. Therefore, the change of the absorbance of the linearly-polarized light component 316 by the solution in the reagent cup 108 over time draws the same graph as the graph illustrated in FIG. 14 in Embodiment 1. That is, the orientation directions of the free molecules and the binding molecules are switched by the change in the vibration direction of the orientation control light 326 at a time T31, and the absorbance of the nanorods 8 with respect to the linearly-polarized light component 316 increases from an original value iz3, but the absorbance is saturated at a value if3 at a time T32 when the orientation of the free molecules is completed. After that, the absorbance increases again at a time T33 as the orientation direction of the binding molecules is switched, and is saturated at a value it3 at a time T34, at which the orientation of all the binding molecules is completed. The output of the polarization direction control signal remains at 5 V for T seconds, and then becomes 0 V When the polarization direction control signal is switched from 5 V to 0 V, the absorbance of the linearly-polarized light component 316 temporarily remains at a value of it3, and then decreases to the value of iz3.

Attention is paid to the linearly-polarized light component 314 transmitting through the polarized beam splitter 310. Since the vibration direction of the linearly-polarized light component 314 and the long-axis direction of the nanorods 8 become parallel by the time T31, the absorbance becomes the maximum. The orientation directions of the free molecules and the binding molecules are switched by the change in the vibration direction of the orientation control light 326 at the time T31, and the absorbance of the nanorods 8 with respect to the linearly-polarized light component 314 decreases from the original value it4. When the free molecules are completely oriented, the absorbance reaches a constant value of if4 at a time T32. After that, the absorbance decreases again at the time T33 as the orientation direction of the binding molecules is switched, and becomes the minimum value at a value iz4 at the time T34, at which the orientation of all the binding molecules is completed. The output of the polarization direction control signal remains at 5 V for T seconds, and then becomes 0 V. When the polarization direction control signal is switched from 5 V to 0 V, the absorbance of the linearly-polarized light component 314 temporarily remains at a value of iz4, and then increases to the value of it4. This is because the vibration direction of the linearly-polarized light component 314 and the long-axis direction of the nanorods 8 return to be parallel.

CPU 320 normalizes the absorbance of the linearly-polarized light component 316 as Pp and the absorbance of the linearly-polarized light component 314 as Pv in accordance with the following formula (3)

K=(Pp−Pv)/(Pp+Pv) (3)

As such, when two absorbances are normalized, the influence of the concentration variation of the nanorods 8, the excitation power change of an optical system and the like can be reduced.

The concentration of the binding molecules is computed from the graph of the normalized absorbance. Specifically, the measured value S3 is obtained using the following formula (4).

S3=(it5−if5)/(it5−iz5) (4)

CPU 320 obtains a diagnosis value C3 (the concentration of the detection subject substance) from the measured value S3 obtained herein using the calibration curve function in the same manner as in Embodiment 1, and the obtained diagnosis value C3 is output to the display unit 102.

As described above, the bio-molecule detecting device 300 according to Embodiment 3 of the invention was configured to be capable of switching the orientation directions of the free molecules and the binding molecules in the solution by switching the vibration direction of the orientation control light 326. In addition, light only having components vibrating in two orthogonal directions was used as the absorbance measurement light 312, the absorbance measurement light 312, which had transmitted thorugh the solution, was separated based on the vibration direction using the polarized beam splitter, and the absorbance of each of the linearly-polarized light components was measured. The influence of the concentration variation of the nanorods 8, the excitation power change of the optical system and the like can be reduced by normalizing the absorbance of each of the linearly-polarized light components obtained in the above manner, and normalizing the normalized absorbance. The extent of contribution of the nanorods associated with the binding molecules in the solution to the absorbance can be computed from the normalized absorbance in the same manner as in Embodiment 1, and the concentration of the detection subject substance can be accurately measured with a simple configuration.

Meanwhile, the respective embodiments according to the invention, which have been described thus far, illustrate examples of the invention, and do not limit the configuration of the invention. The bio-molecule detecting device according to the invention is not limited to the respective embodiments, and can be modified in various manners and carried out within the scope of the object of the invention.

For example, the switching of the orientation direction of the molecules in the solution does not necessarily need to be carried out using light, and may be carried out using a magnetic method or an electrical method as long as an external force that can cause a difference between the necessary time for the switching of the orientation direction of the free molecules and the necessary time for the switching of the orientation direction of the binding molecules to be completed is applied. When the orientation of the molecules is controlled using light, there is an advantage that a complicated mechanism is not required compared with a case in which the orientation of the molecules is controlled using a magnetic force or the like. For example, in order to control the orientation of the molecules using a magnetic force, the respective molecules need to be magnetic, or it is necessary to prepare magnetic molecules and bond the molecules to molecules whose orientations are to be controlled, which makes the preparation for measurement troublesome.

In addition, in the respective embodiments according to the invention, the radiation direction of the orientation control light is switched between two orthogonal directions, but the radiation direction does not necessarily need to be switched between two orthogonal directions. When the free molecules and the binding molecules are oriented in different directions, the absorbance of the nanorods included in the respective molecules is different, and the absorbance of the free molecules per molecule and the absorbance of the binding molecules per molecule are also different. Therefore, the free molecules and the binding molecules can be separated and measured even when the radiation direction of the orientation control light is not set to two orthogonal directions, that is, the orientation direction of the free molecules and the orientation direction of the binding molecules are not set to two orthogonal directions. When the radiation directions of the orientation control light are orthogonal, the time difference for the orientation of the free molecules and the orientation of the binding molecules to be completed becomes the maximum so that S/N becomes most favorable. Meanwhile, when the respective radiation directions of the orientation control light are set to form an angle of 60 degrees, the necessary time for the switching of the orientation direction of the free molecules to be completed and the necessary time for the switching of the orientation direction of the binding molecules to be completed also become shorter compared with a case in which the radiation direction of the orientation control light is switched between two orthogonal directions, and the necessary measurement time also becomes shorter. As such, as the angle formed by two radiation directions of the orientation control light decreases below 90 degrees, the necessary time for the switching of the orientation direction of the free molecules to be completed and the necessary time for the switching of the orientation direction of the binding molecules to be completed also become shorter, and the measurement time also becomes shorter.

In addition, in a case in which only whether or not the detection subject substance is present in the solution needs to be measured, that is, whether or not the binding molecules are present needs to be measured, the radiation direction of the orientation control light may be switched between two directions having an angular difference that can cause a time difference for the orientation directions of the free molecules and the binding molecules to be switched. When a time difference for the orientation directions of the free molecules and the binding molecules to be switched is caused, the difference appears as a change in the absorbance, and therefore the presence of the binding molecules can be confirmed.

In addition, in order to switch the orientation direction of the molecules, the traveling direction of the orientation control light is switched using AOD in Embodiment 1 and Embodiment 2 according to the invention, and the vibration direction of the linearly-polarized orientation control light is switched in Embodiment 3, but the above methods do not necessarily need to be used in order to switch the orientation direction of the molecules. For example, a plurality of orientation control light source units having different radiation directions of the orientation control light may be provided, and the radiation direction of the orientation control light may be switched by switching the orientation control light source units being used.

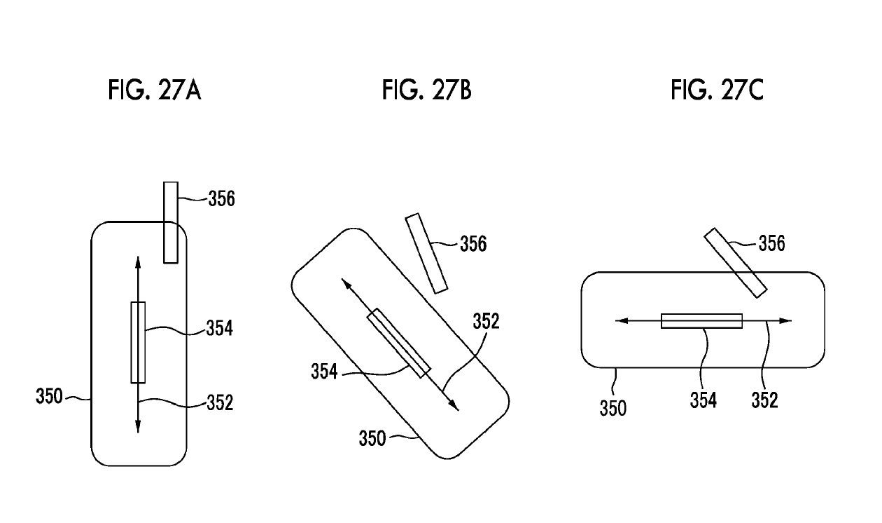

In addition, the number of the orientation control light source units provided in one radiation direction does not necessarily need to be one, and a plurality of orientation control light source units may be provided, and a plurality of orientation control light may be radiated in the same direction. In addition, the orientation control light may have any cross-sectional shape in a direction vertical to the traveling direction. For example, a case in which the linearly-polarized orientation control light 350 vibrating in the vibration direction 352 is radiated can be considered as illustrated in FIG. 27A. In this case, the orientation control light has a substantially rectangular cross-sectional shape in a direction vertical to the traveling direction. At this time, the behaviors of the nanorod 354 located at the center of the orientation control light 350 and the nanorod 356 located at the circumferential edge portion of the orientation control light 350 will be considered.

As illustrated in FIG. 27B, when the polarization axis of the orientation control light 350 is rotationally moved, the nanorod 354 located on the rotational movement axis (the rotational movement center of the polarization axis) rotationally moves in accordance with the rotational movement of the polarization axis. Meanwhile, the nanorod 356 located at the circumferential edge of the orientation control light 350 cannot follow the rotational movement of the polarization axis, and deviates from the polarization axis. After a period of time, the nanorod 356 is pulled to the polarization axis, and oriented. In addition, as illustrated in FIG. 27C, even when the polarization axis of the orientation control light 350 is rotated by 90 degrees with respect to FIG. 27A, the nanorod 354 follows the rotation, but the nanorod 356 cannot follow the rotation, after a period of time, the nanorod is pulled to the orientation control light 350, and oriented. That is, the nanorod 354 located at the center of the polarization axis rotationally moves in synchronization with the vibration direction of the orientation control light, but the movement of the nanorod 356 located at the circumferential edge portion of the polarization axis becomes a revolving-like movement with respect to the center of the polarization axis, and does not synchronize with the vibration direction of the orientation control light.

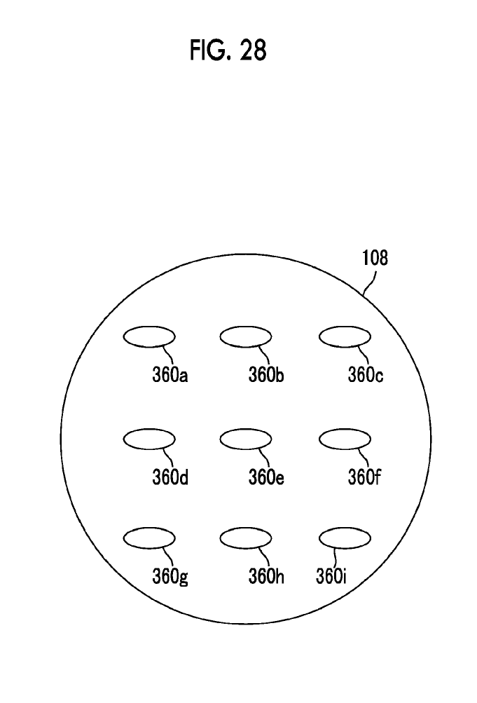

As such, the presence of the nanorod that cannot follow the rotational movement of the polarization axis of the orientation control light has an influence on measurement. In that case, nine rays of the orientation control light may be entered on nine points of 360a to 360i as illustrated in FIG. 28 (the top view of the reagent cup 108). Then, since the number of the nanorods located at the center of the polarization axis of the orientation control light increases, the influence on measurement can be decreased. Meanwhile, here, an example in which the orientation control light is entered on nine points is described, but the number of points on which the orientation control light is entered is not limited to nine, and may be larger or smaller than nine. As the orientation control light is squeezed, the orientation control light is desirably entered into more points. Thereby, the nanorods can be rotated in synchronization with the orientation at a plurality of places. As a result, an unexpected change in the absorbance can be decreased, and the coefficient of variation, which is an index that indicates a relative diffusion, can be improved.

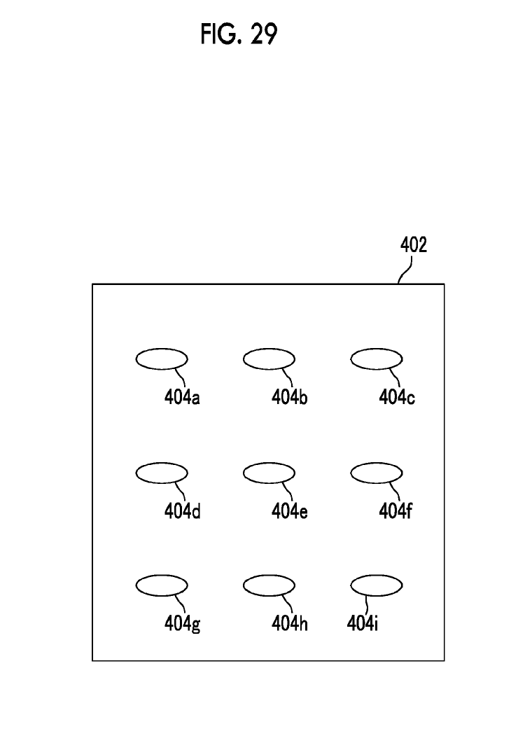

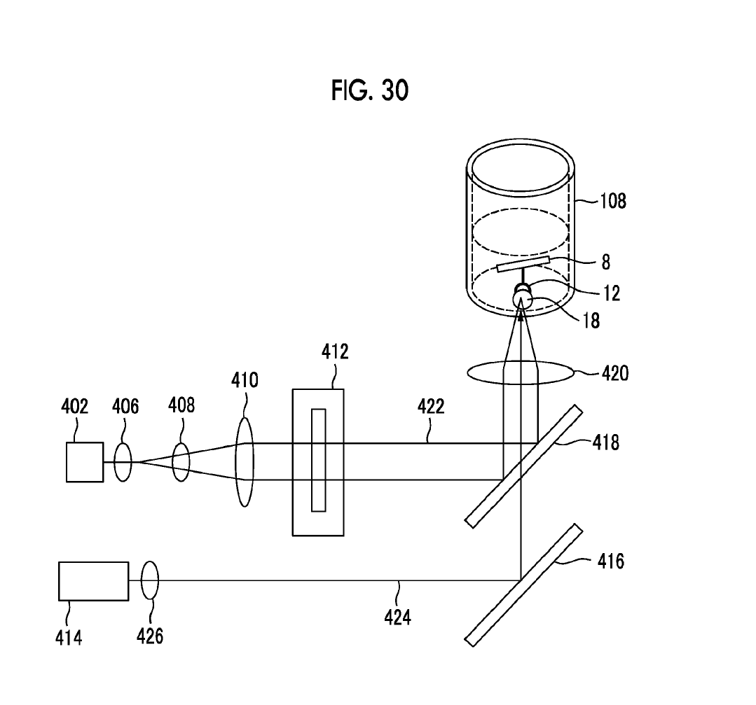

The structure of an orientation control light source unit 402 for entering the orientation control light at multiple points in the above manner will be illustrated in FIG. 29. The orientation control light source unit 402 is a 3><3 two-dimensional laser array. The orientation control light source unit 402 emits light at 9 light-emitting points of 404a to 404i. The size of the light-emitting point is 1 μm in the vertical side and 100 μm in the horizontal side. The distance between the light-emitting points is approximately 100 μm. FIG. 30 illustrates an example of an optical system in which the orientation control light source unit 402 is used. Meanwhile, FIG. 30 does not illustrate configuration components other than the optical system relating to the orientation control light and the absorbance measurement light.

A linearly-polarized orientation control light 422 radiated from the orientation control light source unit 402 passes through a collimator lens 406, and becomes a parallel light ray at the focus. The orientation control light 422, which has passed through the collimator lens 406, passes through a beam expander 408 and a beam expander 410, and enters a half-wavelength plate 412. The orientation control light 422, which has passed through the beam expander 408 and the beam expander 410, is spread into parallel beams of a specific magnification. The half-wavelength plate 412 is located on a rotary stage so as to be rotatable. Thereby, the polarization axis of the orientation control light 422 can be rotationally moved. The orientation control light 422, which has transmitted through the half-wavelength plate 412, is reflected at a dichroic mirror 418, is collected using a lens 420, and enters toward the top surface from the bottom surface of the reagent cup 108.

The absorbance measurement light 424 radiated from the light source unit 414 passes through the lens 426, and is reflected at the dichroic mirror 416. The absorbance measurement light 424 reflected by the dichroic mirror 416 transmits through the dichroic mirror 418, is collected using the lens 420, and enters toward the top surface from the bottom surface of the reagent cup 108.

In the optical system illustrated in FIG. 30, when the focal distance of the collimator lens 406 is set to 3.1 mm, and the focal distance of the lens 420 is set to 4 mm, the magnification becomes 1.29 times. Therefore, on the bottom surface of the reagent cup 108, the size of the orientation control light 422 becomes approximately 1.3 μm×130 μm, and the pitch becomes approximately 129 μm.

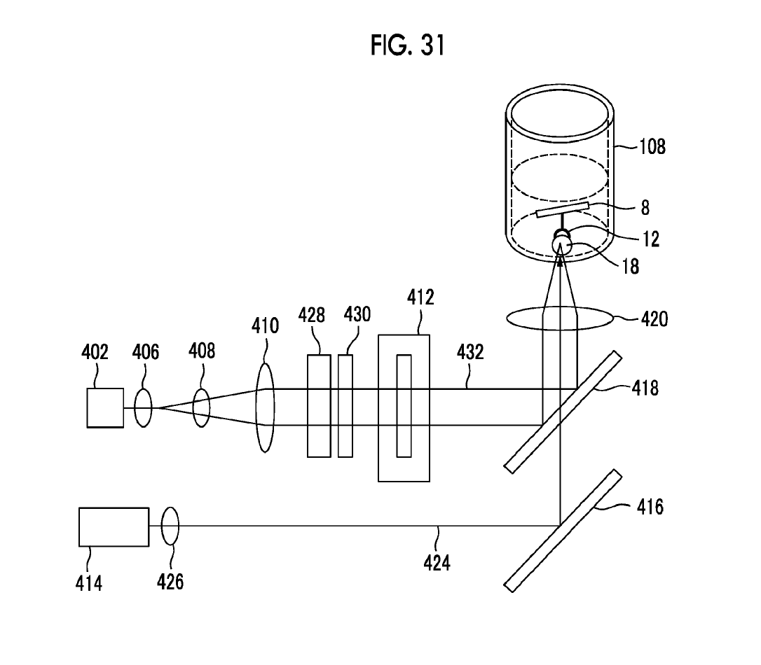

FIG. 31 illustrates an example of another optical system that enters the orientation control light at multiple points. Meanwhile, even FIG. 31 does not illustrate components other than the optical system of the orientation control light and the absorbance measurement light. In addition, the same configuration element as in FIG. 30 will be given the same reference numeral, and will not be described.

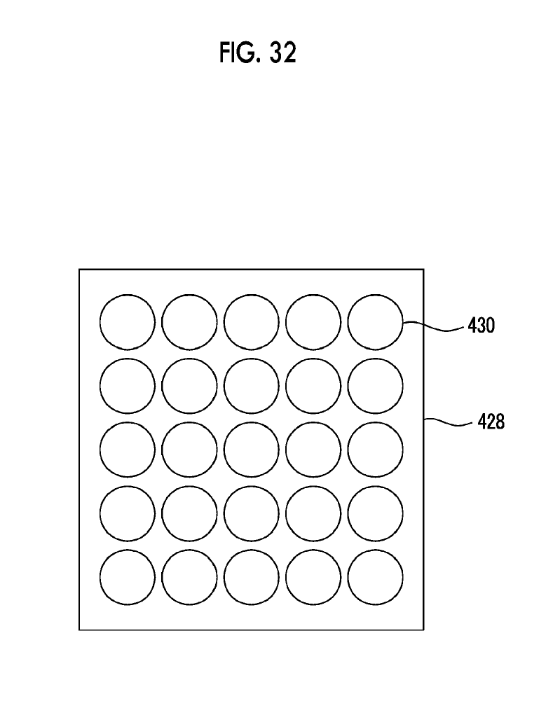

In the optical system illustrated in FIG. 31, the orientation control light source unit 116 is the same as in Embodiment 1. An orientation control light 432 passes through the collimator lens 406, the beam expander 408 and the beam expander 410, and enters a micro lens array 428 The micro lens array 428 has a plurality of micro lenses 430 arrayed in a lattice shape as illustrated in FIG. 32. The orientation control light 432, which has passed through the micro lens array 428, becomes a plurality of beams focused at different locations like light radiated from a plurality of light sources. The orientation control light 432 is squeezed using a pin hole array 430, reflected by the dichroic mirror 418, passes through the lens 420, and enters toward the top surface from the bottom surface of the reagent cup 108. Even when the micro lens array is used as described above, the orientation control light can be entered at multiple points.

In addition, in an optical system in which the radiation direction of the orientation control light is changed as in Embodiment 1, a plurality of steps of optical systems may be prepared in order to radiate orientation light on multiple points. For example, when three steps of the same optical systems are superimposed, the orientation control light is radiated from three orientation control light source units, and the orientation control light can be radiated from three points on the reagent cup 108. Even in this case, the orientation control light can be entered from multiple points, and the nanorods can be rotationally moved at a plurality of places.

Meanwhile, here, the optical system for radiating the linearly-polarized orientation control light from a plurality of locations so as to enter the light at multiple points has been described, but the orientation direction of the nanorods may be switched by entering non-linearly-polarized orientation control light at multiple points and switching the radiation direction. Even in this case, the orientation control light is radiated from a plurality of places using a two-dimensional laser array, a micro lens array or the like. The switching of the radiation direction of the orientation control light may be switched using AOD or the like, or a plurality of light sources having different radiation directions of the orientation control light may be provided so as to switch the light sources being used.

In addition, in the respective embodiments according to the invention, a case in which one reagent cup is provided in the bio-molecule detecting device has been described, but the number of the reagent cups does not necessarily need to be one, and the bio-molecule detecting device may be configured to provide a plurality of reagent cups in the device so that a plurality of specimens can be set. In this case, when the bio-molecule detecting device is configured to sequentially move the reagent cups to measurement locations and carry out measurements, a plurality of specimens can be automatically measured.

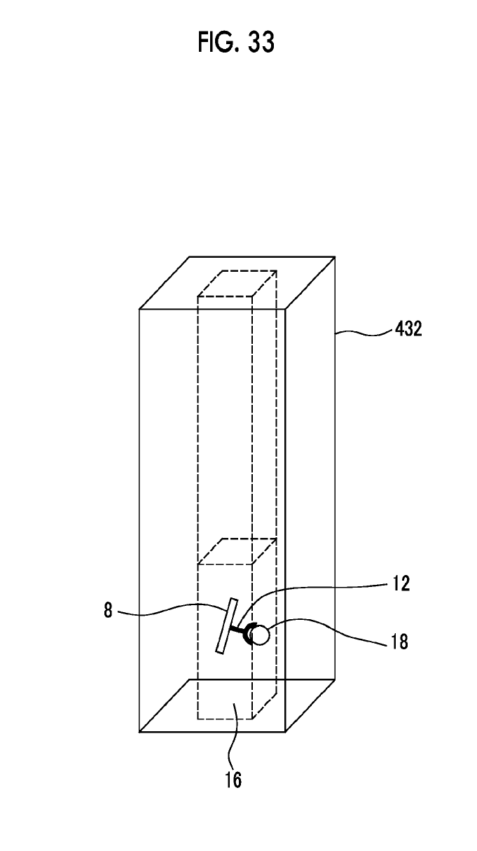

In addition, in the respective embodiments, the reagent cup had a columnar shape, but the reagent cup does not necessarily need to have a columnar shape. For example, as illustrated in FIG. 33, a reagent cup 432 having a quadrangular prism-like shape and a quadrangular prism-like container holding unit therein may also be used. The reagent cup 432 having a quadrangular prism-like container holding unit is suitable particularly for a case in which the free molecules and the binding molecules receive a pressure in the traveling direction of the orientation control light by the orientation control light and are pressed on the container wall surface. The above phenomenon occurs in a case in which the masses of the free molecules and the binding molecules are light, or the like, and is caused by the fact that the free molecules and the binding molecules receive a force from the orientation control light and move in the solution. In this case, when the container holding unit is a quadrangular prism, the free molecules and the binding molecules are pressed and oriented at a plane, which is the interface between the solution and the reagent cup 432. Since the interface is a plane, there is no case in which the free molecules and the binding molecules move horizontally, and deviate from the orientation control light. In addition, in a case in which the free molecules and the binding molecules are pressed on the wall surface, when efforts are made to find a proper location of the focus of the orientation control light, the orientation becomes easier.

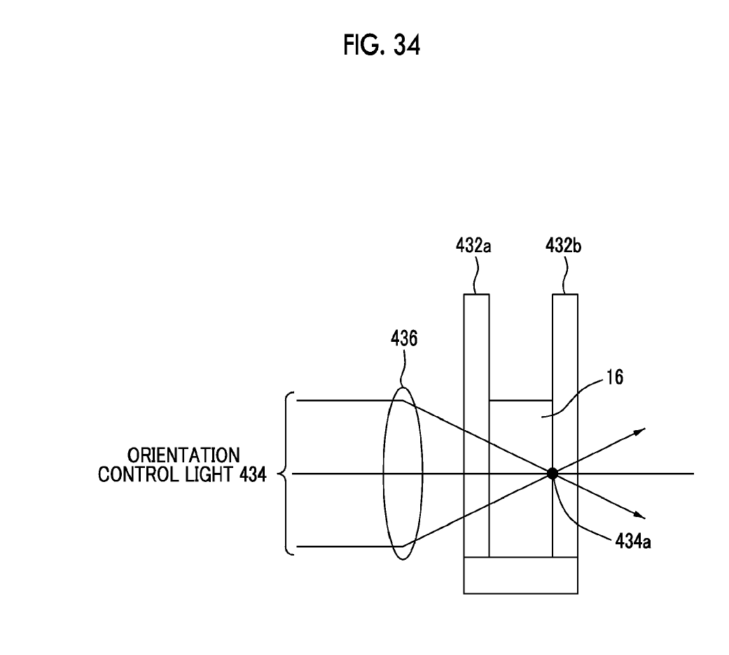

FIG. 34 is a view illustrating an example of the location of the focus of the linearly-polarized orientation control light. The orientation control light 434 enters a lens 436, and have a focus 434a in the interface between the blood plasma 16 and a wall surface 432b of the reagent cup. At the location of the focus of the orientation control light, the orientation control light orients the free molecules and the binding molecules using a strongest force. Therefore, when the orientation control light is entered as illustrated in FIG. 34, the orientation control light can more efficiently orient the free molecules and the binding molecules while pressing the free molecules and the binding molecules on the wall surface 432b at the location of the focus 434c. Even in this case, the orientation directions of the free molecules and the binding molecules can be changed at the location of the focus 434c by rotationally moving the polarization axis of the linearly-polarized orientation control light.

Meanwhile, the container holding unit does not necessarily need to have a quadrangular prism-like shape, and may have any shape as long as the unit has a plane on at least one surface. When the orientation control light is radiated so as to be focused on the plane, the free molecules and the binding molecules are pressed and oriented on the plane without moving horizontally and deviating from the orientation control light.

Meanwhile, in the respective embodiments according to the invention, an example in which the antibodies bonded with the nanorods were used has been described, but the antibodies do not necessarily need to be bonded with the nanorods. For example, the bonding between the antibody and the antigen and the bonding between the antibody and the nanorod may be carried out at the same time in the reagent cup. In this case, the user prepares the antibodies and the nanorods in respectively separate reagent tanks in advance. In the measurement, the bio-molecule detecting device dispenses the antibodies, the nanorods and the specimens into the reagent cups respectively, and causes reactions.

In addition, the orientation control light source unit 116 or the light source unit 118 may be configured to be attachable to and detachable from the bio-molecule detecting device so that the units can be exchanged with an appropriate unit depending on the kinds of the detection subject substance and the nanorod.

In addition, when the detection or quantity determination of the detection subject substance is carried out by switching the direction of the orientation control at predetermined time intervals and arithmetically averaging a plurality of the obtained absorbances, the influence of noise on the measurement accuracy can be reduced, and a higher-accuracy measurement becomes possible.

The predetermined time intervals for switching the direction of the orientation control is desirably set to a necessary time interval for the switching of the orientation directions of all the free molecules present in the solution and all the binding molecules present in the solution to be completed. The necessary time interval for the switching of the orientation directions of all the free molecules and all the binding molecules present in the solution to be completed can be obtained based on, for example, a time during which the absorbance changes. When measurement is repeated several cycles using the bio-molecule detecting device, the approximate necessary time for the absorbance to be saturated is found. The necessary time for the absorbance to be saturated is a necessary time for the switching of the orientation direction of all the free molecules and the binding molecules present in the solution to be completed. Therefore, the necessary time for the absorbance to be saturated is desirably set to the above predetermined time interval. In addition, when the necessary time for the absorbance to be saturated is arithmetically averaged, and the computed time is determined as the predetermined time interval, the influence of variation among the respective measurements, which is caused by noise and the like, can be reduced. When the predetermined time intervals are set in the above manner, there is no case in which the orientation control light is radiated in the same direction even after the orientations of all the free molecules in the solution and all the binding molecules in the solution are completed, and the power consumption can be reduced. Furthermore, the measurement time can also be shortened.

In addition, the necessary time for the orientation directions of all the free molecules present in the solution and all the binding molecules present in the solution to be completely switched can also be obtained from the respective masses or volumes of the free molecules and the binding molecules, the intensity of the external force that controls the orientation using the orientation control unit, the viscosity of a solvent, and the like.

Meanwhile, in the respective embodiments according to the invention, a case in which one antibody is bonded to the nanorod has been described as an example in order to facilitate the description, the number of antibodies that are bonded to the nanorod does not necessarily need to be one.

Meanwhile, in the respective embodiments according to the invention, a case in which the blood plasma separated from whole blood was used as the specimen has been described as an example, the specimen is not limited to the blood plasma separated from whole blood, and urine, saliva or the like can be used as the specimen as long as the detection subject substance is dispersed in the solution.

In addition, in the respective embodiments according to the invention, since measurement is possible in a system having the antigens, the antibodies and the nanorods dispersed in a liquid without using a substrate to which the nanorods and the antibodies are fixed, compared with measurement with antigens and the like fixed to a substrate, there is an advantage that the pretreatment is simple. In addition, since the antigens and the free molecules can freely move around in the solution, there is another advantage that the reaction is fast compared with measurement in a system in which a substrate is used.

In addition, in the respective embodiments according to the invention, a gold nanorod has been described as an example of the nanorod, but the material that configures the nanorod is not limited to gold, and may be any material as long as the material includes a metal that can generate plasmon resonance. For example, silver, copper or the like can be used.

In addition, the size of the nanorod that can be used in the invention is not limited to those of the nanorods used in the respective embodiments of the invention, and may be any size as long as the absorbance of light is changed by the change in the orientation direction.

In addition, in the respective embodiments according to the invention, a case in which the antibody is bonded in the vicinity of the center of the nanorod has been described as an example, the antibody does not necessarily need to be bonded in the vicinity of the center of the nanorod. Even when the antibody is bonded to any location in the nanorod, as long as the antigen is bonded to the antibody, a difference is caused between the degree of ease of the rotation of the free molecules and the degree of ease of the rotation of the binding molecules in the solution. When a difference in the degree of ease of rotation is caused between the free molecules and the binding molecules, the bio-molecule detecting device according to the invention can separate the extent of contribution of the free molecules and the extent of contribution of the binding molecules, and can detect the detection subject substance.

In addition, in the respective embodiments according to the invention, a case in which one antibody is fixed to one nanorod has been described as an example, the number of the antibodies fixed to the nanorod does not necessarily need to be one. A plurality of antibodies may be fixed to one nanorod.

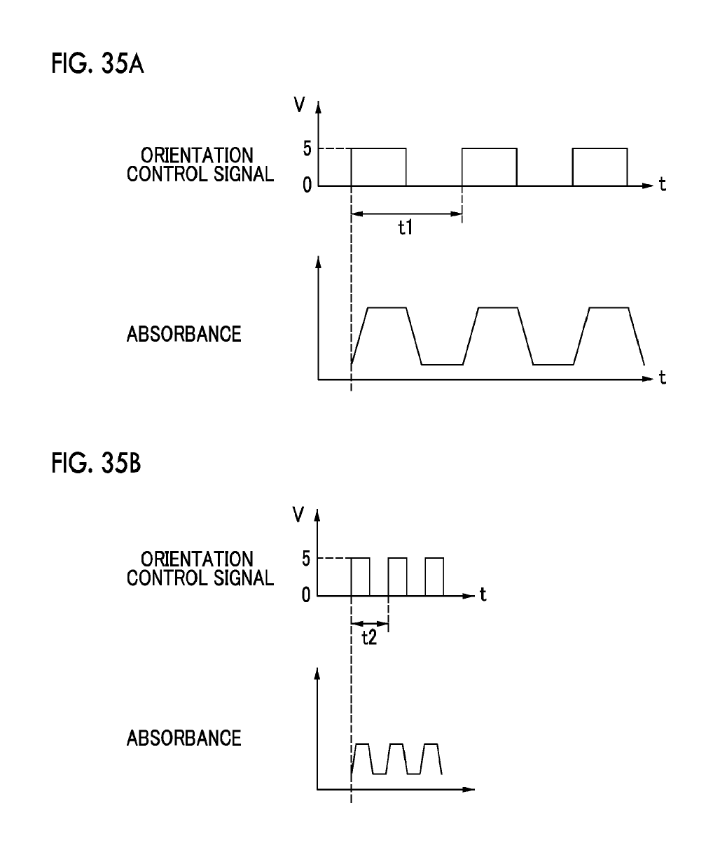

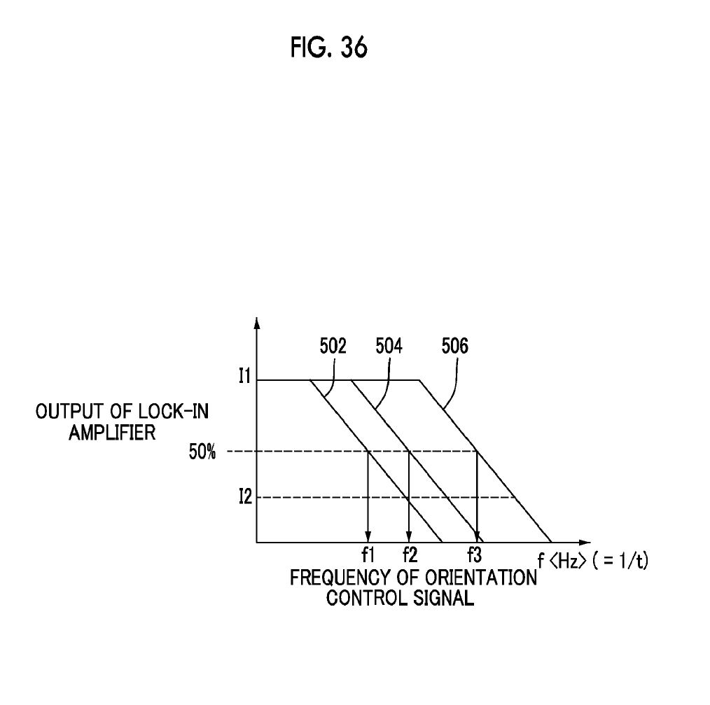

In addition, in the respective embodiments according to the invention, the concentration of the binding molecules has been obtained based on the value of the saturated absorbance, but the concentration does not necessarily need to be obtained using the above method. For example, as illustrated in FIGS. 35A and 35B, a component synchronized with the frequency of the orientation control signal is extracted by changing the frequency of the orientation control signal and using the lock-in amplifier. In FIG. 35A, since the cycle t1 of the orientation control signal is sufficiently long, and the time period during which the orientation control signal is set to 5 V is long, all the free molecules and the binding molecules are oriented, the absorbance becomes the maximum value, and the output of the lock-in amplifier becomes a maximum value I1. Meanwhile, in FIG. 35B, since the cycle t2 of the orientation control signal is short, and the orientation control signal becomes 0 V before all the free molecules and the binding molecules are oriented, the absorbance does not become the maximum value, and the output of the lock-in amplifier becomes I2. I2 is smaller than T1. FIG. 36 illustrates an example of graphs of the estimated calibration curve data obtained for the output of the lock-in amplifier with respect to the frequencies, at which the values of the orientation control signal are switched, for the concentrations of three kinds of binding molecules in the same manner.

As the concentration of the antigen increases, the concentration of the binding molecules increases, and the binding molecules have a larger mass and a larger volume than the free molecules, the binding molecules cannot easily follow the switching of the orientation control signal. That is, as the concentration of the antigen increases, it is necessary to set the orientation control signal to 5 V for a long period of time in order to set the output of the lock-in amplifier to the maximum value I1, and the cycle of the orientation control signal needs to be long. Since the frequency is an inverse number of the cycle, as the concentration of the antigen in the solution increases, the maximum value of the frequency, at which the output of the lock-in amplifier becomes I1, decreases. Conversely, as the concentration of the antigen in the solution decreases, the maximum value of the frequency, at which the output of the lock-in amplifier becomes I1, increases. For example, in the three kinds of calibration curves illustrated in FIG. 36, the antigen concentration is largest in the calibration curve 502, second largest in the calibration curve 504, and smallest in the calibration curve 506. For example, it is found that, in a case in which the frequency, at which the output of the lock-in amplifier obtained by measuring the solution becomes half the maximum value, is f1, the calibration curve matches the calibration curve 502, and the concentration of the antigens when the calibration curve 502 is obtained is output as the concentration of the antigens in the solution.

In addition, in the respective embodiments according to the invention, the quantity of the detection subject substance is determined based on the measurement of the absorbance, but the absorbance is not the only parameter that can be measured. For example, in addition to the absorbance, the light extinction amount of light may be measured by measuring scattered light by the free molecules and the binding molecules. The light extinction amount is made up of the contributions of both the amount of absorbed light and the amount of scattered light. Therefore, the light extinction amount of the orientation control light can be obtained by investigating the light amounts of the orientation control light before and after the transmission of the solution so as to measure the absorbance of the orientation control light by the free molecules and the binding molecules, and measuring the scattered light of the orientation control light by the free molecules and the binding molecules. In addition, only the scattered light of the orientation control light by the free molecules and the binding molecules may be measured. The intensity of the orientation control light scattered by the free molecules and the binding molecules changes depending on the orientation direction of the free molecules and the binding molecules in the same manner as for the absorbance of the orientation control light. Therefore, even when only the scattered light is measured, the intensity can be measured in the same manner as a case in which the absorbance is measured. In a case in which the scattered light is measured, the measurement is generally carried out using a method in which a dark-field microscope is used. That is, annular light having a large number of apertures (NA) is illuminated, the annular light is cut on a light-receiving side, and only scattered light is received. The annular light refers to light having a ring-shaped cross-section.

Meanwhile, since the spectrum of the orientation control light scattered by the free molecules and the binding molecules is already known, in order to measure the orientation control light scattered by the free molecules and the binding molecules, a bandpass filter that passes only light having a wavelength of the scattered light may be provided in the light-receiving unit. In addition, in a case in which both the absorbance and the scattered light are measured, that is, in a case in which the transmitted light and the scattered light are received, light outgoing from the solution including the free molecules and the binding molecules may be dispersed using a dichroic mirror, and the transmitted light and the scattered light may be received respectively through the band pass filter.

The bio-molecule detecting device and bio-molecule detecting method according to the invention can be used in, for example, a device that carries out the detection and quantity determination of a detection subject substance using an interaction between the detection subject substance and a substance that specifically bonds to the detection subject substance.

What is claimed is:

1. A bio-molecule detecting device comprising:
an orientation control unit that, in a solution including first complexes having a substance that can specifically bond to a specific bio-molecule and a detection label exhibiting anisotropic light absorption characteristics and second complexes in which the bio-molecule is specifically bonded to the first complexes through the substance, orients the first complexes and the second complexes in at least two directions;
a first light source that radiates first light having a linearly-polarized light component in a specific direction on the solution;
a detection unit that measures a light extinction amount of the first light by the solution; and
a computation unit that carries out detection or quantity determination of the bio-molecule based on the light extinction amount of the light measured using the detection unit,
wherein the first light is light having a wavelength at which the light extinction amount by the detection label is changed by a change in orientation directions of the first complexes and the second complexes.

2. The bio-molecule detecting device according to claim 1, wherein the first light is light in which changes in the orientation directions of the first complexes and the second complexes using the orientation control unit causes a change in the orientation relationship between the detection label and the linearly-polarized light component in a specific direction so that the light extinction amount by the detection label changes.

3. The bio-molecule detecting device according to claim 2,
wherein the orientation control unit includes a second light source that radiates second light on the solution; and
a switching unit that orients the first complexes and the second complexes in at least two directions in the solution by switching the radiation direction of the second light.

4. The bio-molecule detecting device according to claim 2, wherein the orientation control unit includes a third light source that radiates third linearly-polarized light on the solution; and
a polarization axis rotational movement unit that orients the first complexes and the second complexes in at least two directions in the solution by rotationally moving the polarization axis of the third light.

5. The bio-molecule detecting device according to claim 1,
wherein the computation unit separates a light extinction amount component by the first complexes and a light extinction amount component by the second complexes using a fact that there is a difference in the changes of the light extinction amounts over time by the first complexes and by the second complexes, which are oriented using the orientation control unit, and carries out the detection or quantity determination of the bio-molecule.

6. The bio-molecule detecting device according to claim 1,
wherein the detection label is a metal nanorod.

7. The bio-molecule detecting device according to claim 6,
wherein the orientation control unit orients the first complexes and the second complexes in a first direction in which a long-axis direction of the metal nanorod and the vibration direction of the light radiated from the first light source become parallel, and
in a second direction in which a long-axis direction of the metal nanorod and the vibration direction of the light radiated from the first light source become vertical.

8. The bio-molecule detecting device according to claim 1,
wherein the orientation control unit changes the orientation directions of the first complexes and the second complexes at predetermined time intervals,
the detection unit measures the light extinction amount a plurality of times, and
the computation unit carries out the detection or quantity determination of the bio-molecule based on the arithmetic average of the light extinction amounts measured a plurality of times.

9. The bio-molecule detecting device according to claim 8,
wherein the predetermined time interval is a time interval during which the orientations of all the first complexes present in the solution and all the second complexes present in the solution are completed.

10. The bio-molecule detecting device according to claim 6,
wherein the wavelength of the light radiated from the first light source is a wavelength at which the maximum value of the light extinction amount derived from the long-axis direction of the metal nanorod appears.

11. The bio-molecule detecting device according to claim 3,
wherein the solution is held in a container holding unit having a quadrangular prism-like shape.

12. The bio-molecule detecting device according to claim 11,
wherein the second light source radiates the second light so that the second light is focused at a location at which the second light outgoes from the container holding unit.

13. The bio-molecule detecting device according to claim 11,
wherein the second light source radiates the second light on the solution from a plurality of locations.

14. The bio-molecule detecting device according to claim 4,
wherein the solution is held in a container holding unit having a quadrangular prism-like shape.

15. The bio-molecule detecting device according to claim 11,
wherein the third light source radiates the third light so that the third light is focused at a location at which the third light outgoes from the container holding unit.

16. The bio-molecule detecting device according to claim 14,
wherein the third light source radiates the third light on the solution from a plurality of locations.

17. The bio-molecule detecting device according to claim 1,
wherein the detection unit measures the absorbance of the first light by the solution as the light extinction amount.

18. The bio-molecule detecting device according to claim 1,
wherein the detection unit measures the scattered light of the first light by the solution as the light extinction amount.

19. A bio-molecule detecting method comprising:
by using the bio-molecule detecting device according to claim 1,
a step of, in a solution including first complexes having a substance that can specifically bond to a specific bio-molecule and a detection label exhibiting anisotropic light absorption characteristics and second complexes in which the bio-molecule is specifically bonded to the first complexes through the substance, orienting the first complexes and the second complexes in at least two directions;
a step of radiating first light having a linearly-polarized light component in a specific direction on the solution;
a step of measuring a light extinction amount of the first light by the solution; and
a step of carrying out detection or quantity determination of the bio-molecule based on the light extinction amount of the light measured using the detection unit,
wherein the first light is light having a wavelength at which the light extinction amount by the detection label is changed by a change in orientation directions of the first complexes and the second complexes.
